(19) United States
(12) Patent Application Publication
(10) Pub. No.: US 2023/0345498 A1
(43) Pub. Date: Oct. 26, 2023

(54) METHOD AND APPARATUS FOR TRANSMISSION AND RECEPTION OF CONTROL INFORMATION IN WIRELESS COMMUNICATION SYSTEM

(71) Applicant: SAMSUNG ELECTRONICS CO., LTD., Suwon-si (KR)

(72) Inventors: Youngrok JANG, Suwon-si (KR); Kyungjun CHOI, Suwon-si (KR); Ameha Tsegaye ABEBE, Suwon-si (KR); Seongmok LIM, Suwon-si (KR); Hyoungju JI, Suwon-si (KR)

(21) Appl. No.: 18/304,140

(22) Filed: Apr. 20, 2023

(30) Foreign Application Priority Data
Apr. 22, 2022 (KR) 10-2022-0049935

(51) Int. Cl. H04W 72/23; H04L 5/00

(52) U.S. Cl. CPC H04W 72/23; H04L 5/0053

(57) ABSTRACT

The disclosure relates to a 5G or 6G communication system for supporting a higher data transmission rate. The disclosure may include receiving, from a base station, configuration information related to a control channel, the configuration information related to the control channel including first control resource set information and first search space information, and second control resource set information and second search space information, and receiving, from the base station, a signal of physical downlink control channel (PDCCH) repetition transmission, based on the configuration information related to the control channel, the first search space information may include a first bitmap related to a frequency location, and the second search space information may include a second bitmap related to a frequency location.

### CROSS-REFERENCE TO RELATED APPLICATION

This application is based on and claims priority under 35 U.S.C. § 119 to Korean Patent Application No. 10-2022-004935, filed on Apr. 22, 2022, in the Korean Intellectual Property Office, the disclosure of which is incorporated by reference herein in its entirety.

### BACKGROUND

### 1. Field

The disclosure relates generally to a wireless communication system, and more particularly, a method and an apparatus for transmitting and receiving control information in the wireless communication system.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 39 GHz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

As various services are provided with the advance of the wireless communication system as discussed above, a solution for seamlessly providing such services is required. In particular, a technique for repetitively transmitting and receiving control information in the wireless communication system is demanded.

Disclosed embodiments are to provide an apparatus and a method for effectively providing a service in a mobile communication system.

### SUMMARY

According to various embodiments of the disclosure, in a wireless communication system, a method of a terminal for transmitting and receiving control information may include receiving, from a base station, configuration information related to a control channel, the configuration information related to the control channel including first control resource set information and first search space information, and second control resource set information and second search space information, and receiving, from the base station, a signal of physical downlink control channel (PDCCH) repetition transmission, based on the configuration information related to the control channel, the first search space information may include a first bitmap related to a frequency location, and the second search space information may include a second bitmap related to a frequency location.

According to various embodiments of the disclosure, in a wireless communication system, an apparatus of a terminal for transmitting and receiving control information may include a transceiver, and at least one processor connected with the transceiver, the at least one processor may be configured to receive, from a base station, configuration information related to a control channel, the configuration information related to the control channel including first control resource set information and first search space information, and second control resource set information and second search space information, and to receive, from the base station, a signal of PDCCH repetition transmission, based on the configuration information related to the control channel, the first search space information may include a first bitmap related to a frequency location, and the second search space information may include a second bitmap related to a frequency location.

According to various embodiments of the disclosure, in a wireless communication system, a method of a base station for transmitting and receiving control information may include transmitting, to a terminal, configuration information related to a control channel, the configuration information related to the control channel including first control resource set information and first search space information, and second control resource set information and second search space information, and transmitting, to the terminal, a signal of PDCCH repetition transmission, based on the configuration information related to the control channel, the first search space information may include a first bitmap related to a frequency location, and the second search space information may include a second bitmap related to a frequency location.

Disclosed embodiments are to provide an apparatus and a method for effectively providing a service in a mobile communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a fundamental structure of a time-frequency domain in a wireless communication system according to an embodiment of the present disclosure;

FIG. 2 illustrates frame, subframe, and slot structures in a wireless communication system according to an embodiment of the present disclosure;

FIG. 3 illustrates an example of bandwidth part configuration in a wireless communication system according to an embodiment of the present disclosure;

FIG. 4 illustrates an example of control resource set configuration of a downlink control channel in a wireless communication system according to an embodiment of the present disclosure;

FIG. 5A illustrates a downlink control channel structure in a wireless communication system according to an embodiment of the present disclosure;

FIG. 5B illustrates a span that a terminal may have a plurality of PDCCH monitoring occasions within a slot in a wireless communication system according to an embodiment of the present disclosure;

FIG. 6 illustrates an example of a DRX operation in a wireless communication system according to an embodiment of the present disclosure;

FIG. 7 illustrates an example of base station beam allocation according to TCI state configuration in a wireless communication system according to an embodiment of the present disclosure;

FIG. 8 illustrates an example of a TCI state allocation method for a PDCCH in a wireless communication system according to an embodiment of the present disclosure;

FIG. 9 illustrates a TCI indication MAC CE signaling structure for a PDCCH demodulation reference signal (DMRS) in a wireless communication system according to an embodiment of the present disclosure;

FIG. 10 illustrates an example of a control resource set and a search space beam configuration in a wireless communication system according to an embodiment of the present disclosure;

FIG. 11 illustrates a method of a base station and a terminal for transmitting and receiving data by considering a downlink control channel and a rate matching resource in a wireless communication system according to an embodiment of the present disclosure;

FIG. 12 illustrates a method of a terminal for selecting a receivable control resource set by considering a priority in downlink control channel reception in a wireless communication system according to an embodiment of the present disclosure;

FIG. 13 illustrates a wireless protocol architecture of a base station and a terminal with a single cell, carrier aggregation, and dual connectivity in a wireless communication system according to an embodiment of the present disclosure;

FIG. 14A illustrates an antenna port configuration and resource allocation example for cooperative communication in a wireless communication system according to an embodiment of the present disclosure;

FIG. 14B illustrates a downlink control information (DCI) configuration example for cooperative communication in a wireless communication system according to an embodiment of the present disclosure;

FIG. 15 illustrates a PDCCH repetitively transmitted according to an embodiment of the present disclosure;

FIG. 16 illustrates a control resource set configuration method according to an embodiment of the present disclosure;

FIG. 17 illustrates an example of PDCCH repetitive transmission in an unlicensed band according to an embodiment of the present disclosure;

FIG. 18 illustrates another example of PDCCH repetitive transmission in an unlicensed band according to an embodiment of the present disclosure;

FIG. 19 illustrates a terminal structure in a wireless communication system according to an embodiment of the present disclosure; and

FIG. 20 illustrates a base station structure in a wireless communication system according to an embodiment of the present disclosure.

### DETAILED DESCRIPTION

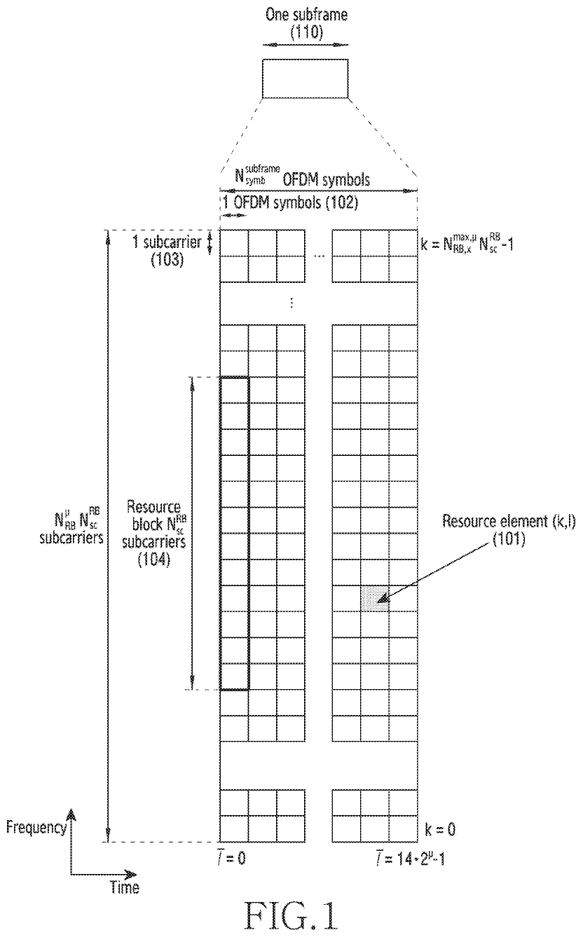

FIGS. 1 through 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure are described in detail with reference to the accompanying drawings.

In describing the embodiments, technical contents well known in the technical field to which the disclosure pertains and which are not directly related to the disclosure will be omitted in the specification. This is to more clearly provide the subject matter of the disclosure by omitting unnecessary descriptions without obscuring the subject matter of the disclosure.

For the same reason, some components in the accompanying drawings are exaggerated, omitted, or schematically illustrated. Also, a size of each component does not entirely reflect an actual size. The same reference number is given to the same or corresponding element in each drawing.

Advantages and features of the disclosure, and methods for achieving them will be clarified with reference to embodiments described below in detail together with the accompanying drawings. However, the disclosure is not limited to the embodiments disclosed below but may be implemented in various different forms, the embodiments are provided to only complete the scope of the disclosure and to allow those skilled in the art to which the disclosure pertains to fully understand a category of the disclosure, and the disclosure is solely defined within the scope of the claims. The same reference numeral refers to the same element throughout the specification. Also, in describing the disclosure, a detailed description of a related known function or configuration will be omitted if it is deemed to make the gist of the disclosure unnecessarily vague. Terms to be described hereafter have been defined by taking into consideration functions in the disclosure, and may be different depending on a user or an operator's intention or practice. Accordingly, they should be defined based on contents over the entire specification.

Hereafter, a base station is an entity which performs resource assignment of a terminal, and may be at least one of a gNode B, an eNode B, a Node B, a base station (BS), a radio access unit, a BS controller and a node on a network. The terminal may include a user equipment (UE), a mobile station (MS), a cellular phone, a smartphone, a computer and a multimedia system for performing a communication function. In the disclosure, downlink (DL) indicates a radio transmission path of a signal transmitted from the base station to the terminal, and uplink (UL) indicates a radio transmission path of a signal transmitted from the terminal to the base station. In addition, a long term evolution (LTE) or LTE-advanced (A) system may be explained as an example, but the embodiments of the disclosure may be applied to other communication system having a similar technical background or channel type. For example, a 5th generation (5G) mobile communication technology (new radio (NR)) developed after the LTE-A may be included therein, and the 5G may be a concept embracing the existing LTE and LTE-A and other similar services. Further, the disclosure may also be applied to other communication systems through some modifications without significantly departing from the range of the disclosure based on determination of those skilled in the technical knowledge.

At this time, it will be understood that each block of the process flowchart illustrations and combinations of the flowchart illustrations may be executed by computer program instructions. Since these computer program instructions may be mounted on a processor of a general purpose computer, a special purpose computer or other programmable data processing apparatus, the instructions executed by the processor of the computer or other programmable data processing equipment may generate means for executing functions described in the flowchart block(s). Since these computer program instructions may also be stored in a computer-usable or computer-readable memory which may direct a computer or other programmable data processing equipment to function in a particular manner, the instructions stored in the computer-usable or computer-readable memory may produce a manufacture article including instruction means which implement the function described in the flowchart block(s). Since the computer program instructions may also be loaded on a computer or other programmable data processing equipment, a series of operational steps may be performed on the computer or other programmable data processing equipment to produce a computer-executed process, and thus the instructions performing the computer or other programmable data processing equipment may provide steps for executing the functions described in the flowchart block(s).

In addition, each block may represent a portion of a module, a segment or code which includes one or more executable instructions for implementing a specified logical function(s). Also, it should be noted that the functions mentioned in the blocks may occur out of order in some alternative implementations. For example, two blocks shown in succession may in fact be executed substantially concurrently or the blocks may sometimes be executed in the reverse order depending on corresponding functionality.

At this time, the term “˜unit” as used in the present embodiment indicates software or a hardware component such as a field programmable gate array (FPGA) or an application-specific integrated circuit (ASIC), and “˜unit” performs specific roles. However, “˜unit” is not limited to software or hardware. “˜unit” may be configured to reside on an addressable storage medium and configured to reproduce on one or more processors. Accordingly, “˜unit” may include, for example, components such as software components, object-oriented software components, class components and task components, processes, functions, attributes, procedures, sub-routines, segments of program code, drivers, firmware, microcode, circuitry, data, databases, data structures, tables, arrays, and variables. The functionalities provided in the components and “˜unit” may be combined to fewer components and “˜units” or may be further separated into additional components and “˜units.” Further, the components and “˜units” may be implemented to reproduce one or more central processing units (CPUs) within a device or a security multimedia card. Also, “˜unit” in one embodiment may include one or more processors.

A wireless communication system is evolving from its early voice-oriented service to, for example, a broadband wireless communication system which provides high-speed, high-quality packet data services according to communication standards such as high-speed packet access (HSPA) of 3rd generation partnership project (3GPP), LTE or evolved universal terrestrial radio access (E-UTRA), LTE-A, LTE-Pro, high-rate packet data (HRPD) of 3GPP2, ultra-mobile broadband (UMB), and institute of electrical and electronics engineers (IEEE) 802.16e.

As a representative example of the broadband wireless communication system, the LTE system employs an orthogonal frequency division multiplexing (OFDM) scheme in the DL, and a single-carrier frequency-division multiple access (SC-FDMA) scheme in the UL. The UL indicates a radio link through which a UE or an MS transmits data or a control signal to an eNode B or a BS, and the DL indicates a radio link through which an eNode B or a BS transmits data or a control signal to a UE or an MS. Such a multi-access scheme generally distinguishes data or control information of each user by assigning and operating time-frequency resources for carrying data or control information of each user not to overlap, that is, to establish orthogonality.

As a future communication system after the LTE, that is, the 5G communication system should be able to freely reflect various requirements of users and service providers, and accordingly the 5G communication system should support a service for simultaneously satisfying various requirements. Services considered for the 5G communication systems includes enhanced mobile broadband (eMBB), massive machine type communication (mMTC), ultra reliability low latency communication (URLLC) and so on.

The eMBB aims to provide a faster data rate than a data rate supported by existing LTE, LTE-A or LTE-Pro. For example, the eMBB in the 5G communication system should be able to provide a peak data rate of 20 gigabits per second (Gbps) in the DL and 10 Gbps in the UL in terms of one base station. In addition, the 5G communication system should provide the peak data rate and concurrently provide an increased user perceived data rate of the terminal. To satisfy these requirements, improvements of various transmission and reception technologies are required, including a further advanced multi input multi output (MIMO) transmission technology. In addition, while signals are transmitted using a maximum 20 megahertz (MHz) transmission bandwidth in a 2 GHz band used by the LTE, the 5G communication system uses a frequency bandwidth wider than 20 MHz in the frequency band of 3-6 GHz or 6 GHz or higher, thus satisfying the required data rate in the 5G communication system.

At the same time, the 5G communication system is considering the mMTC to support application services such as Internet of thing (IoT). The mMTC requires large-scale terminal access support in a cell, terminal coverage enhancement, improved battery time, and terminal cost reduction to efficiently provide the IoT. The IoT is attached to various sensors and various devices to provide communication functions and accordingly should be able to support a great number of terminals (e.g., 1,000,000 terminals/km²) in the cell. In addition, the terminal supporting the mMTC is highly likely to be located in a shaded area not covered by the cell such as a basement of building due to its service characteristics, and thus may require wider coverage than other services provided by the 5G communication system. A terminal supporting the mMTC should be configured with a low-priced terminal, and may require a quite long battery lifetime such as 10-15 years because it is difficult to frequently replace the battery of the terminal.

Finally, the URLLC is a cellular-based wireless communication service used for mission-critical purposes. For example, services used for robot or machinery remote control, industrial automation, unmanaged aerial vehicle, remote health care, emergency situation, or the like may be considered. Thus, the communication provided by the URLLC should provide very low latency and very high reliability. For example, a service supporting the URLLC should meet air interface latency smaller than 0.5 milliseconds and at the same time has requirements of a packet error rate below 10-5. Hence, for the service supporting the URLLC, the 5G system should provide a transmit time interval (TTI) smaller than other services, and concurrently requires design issues for allocating a wide resource in the frequency band to obtain communication link reliability.

Three services of the 5G, that is, the eMBB, the URLLC, and the mMTC may be multiplexed and transmitted in one system. At this time, to satisfy the different requirements of the respective services, different transmission and reception schemes and transmission and reception parameters may be used between the services. Notably, the 5G is not limited to the aforementioned three services.

[NR Time-Frequency Resources]

Hereafter, a frame structure of the 5G system will be described in more detail with reference to the drawing.

FIG. 1 illustrates a fundamental structure of a time-frequency domain in a wireless communication system according to an embodiment of the present disclosure.

A horizontal axis indicates the time domain, and a vertical axis indicates the frequency domain in FIG. 1. A resource basic unit in the time and frequency domains is a resource element (RE) 101 and may be defined as one OFDM symbol 102 on the time axis and one subcarrier 103 on the frequency axis. N_{SC}^{RB} (e.g., 12) consecutive REs may constitute one resource block (RB) 104 in the frequency domain.

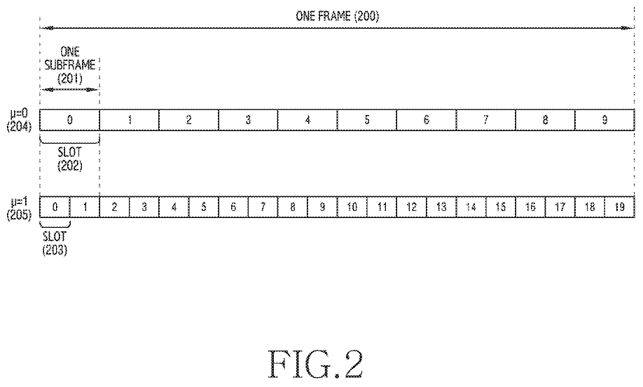

FIG. 2 illustrates frame, subframe, and slot structures in a wireless communication system according to an embodiment of the present disclosure.

FIG. 2 illustrates the example of structures of a frame 200, a subframe 201, and a slot 202. One frame 200 may be defined as 10 ms. One subframe 201 may be defined as 1 ms, and accordingly one frame 200 may include 10 subframes 201 in total. One slot 202 and 203 may be defined as 14 OFDM symbols (i.e., the number of symbols N_{symb}^{slot} for one slot=14). One subframe 201 may include one or more slots 202 and 203, and the number of the slots 202 and 203 for one subframe 201 may vary depending on a subcarrier spacing configuration value p 204 or 205. The example of FIG. 2 illustrates that μ=0 204 and μ=1 205 as the subcarrier spacing configuration value. One subframe 201 may include one slot 202 if μ=0 204, and one subframe 201 may include two slots 203 if μ=1 205. That is, the number of slots Nₛₗₒₜ^{subframe,μ} for one subframe may vary depending on the subcarrier spacing configuration value μ, and accordingly the number of slots Nₛₗₒₜ^{frame,μ} for one frame may vary. Nₛₗₒₜ^{subframe,μ} and Nₛₗₒₜ^{frame,μ} depending on each subcarrier spacing configuration value p may be defined as shown in the following Table 1.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

[Bandwidth Part (BWP)]

Next, BWP configuration in the 5G communication system is described in detail with reference to the drawings.

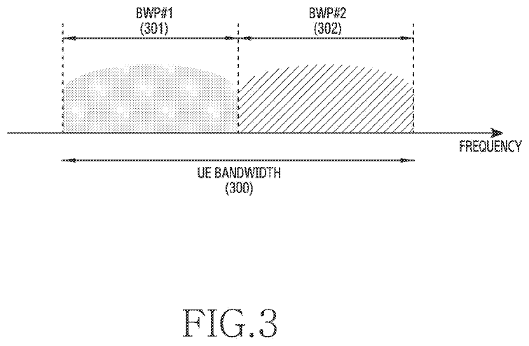

FIG. 3 illustrates an example of BWP configuration in a wireless communication system according to various embodiments of the present disclosure.

FIG. 3 shows the example in which a UE bandwidth 300 includes two BWPs, that is, a BWP #1 301 and a BWP #2 302. The eNode B may configure one or more BWPs for the UE, and configure information shown in Table 2 for each BWP.

TABLE 2

| | |
|---|---|
| BWP ::= | SEQUENCE { |

| | |
|---|---|
| bwp-Id | BWP-Id, |
| locationAndBandwidth | INTEGER (1..65536), |
| subcarrierSpacing | ENUMERATED {n0, n1, n2, n3, n4, n5}, |
| cyclicPrefix | ENUMERATED { extended } |
| } | |

The BWP configuration is not limited to the example of Table 2, and various parameters related to the BWP besides the configuration information of Table 2 may be configured for the UE. The eNode B may transmit the configuration information to the UE through higher layer signaling, for example, radio resource control (RRC) signaling. At least one of the one or more BWPs configured may be activated. Whether to activate the configured BWP may be transmitted from the eNode B to the UE semi-statically through the RRC signaling or dynamically through downlink control information (DCI).

According to an embodiment, an initial BWP for initial access may be configured from the base station for the UE prior to an RRC connection through a master information block (MIB). More specifically, the UE may receive configuration information of a control resource set (CORESET) and a search space for transmitting a physical downlink control channel (PDCCH) to receive remaining system information (RMSI)(or system information block 1 (SIB1)) required for the initial access through the MIB at the initial access. The CORESET and the search space configured with the MIB each may be regarded as an identity (ID) 0. The eNode B may notify the UE of configuration information such as frequency allocation information, time allocation information, numerology, and so on, of a CORESET #0 through the MIB. In addition, the eNode B may notify the UE of monitoring periodicity and occasion configuration information for the CORESET #0, that is, configuration information of a search space #0, through the MIB. The UE may regard the frequency domain configured with the CORESET #0 obtained from the MIB as the initial BWP for the initial access. In so doing, the ID of the initial BWP may be regarded as 0.

According to embodiments of the disclosure, BWP configuration supported in the 5G may be used for various purposes.

According to an embodiment, if a bandwidth supported by the UE is smaller than a system bandwidth, it may be supported through the BWP configuration. For example, the eNode B may configure frequency location (configuration information 2) of the BPW for the UE, and thus the UE may transmit and receive data at a specific frequency location within the system bandwidth.

According to an embodiment, the eNode B may configure a plurality of BWPs for the UE to support different numerologies. For example, to support data transmission and reception using the subcarrier spacing of 15 kHz and the subcarrier spacing of 30 kHz for any UE, two BWPs may be configured with the subcarrier spacings of 15 kHz and 30 kHz respectively. Frequency division multiplexing may be performed on the different BWPs, and the BWP configured with a corresponding subcarrier spacing may be activated, to transmit and receive data with a specific subcarrier spacing.

According to an embodiment, the eNode B may configure BWPs having different bandwidths to the UE for the sake of power consumption reduction of the UE. For example, if the UE supports a very large bandwidth, for example, a 100 MHz bandwidth, and always transmits and receives data through the corresponding bandwidth, considerable power consumption may be caused. In particular, it may be highly inefficient in terms of the power consumption to monitor an unnecessary downlink control channel with the great bandwidth of 100 MHz in absence of traffic. The eNode B may configure a BWP of a relatively small bandwidth, for example, a 20 MHz BWP, to the UE, to reduce the power consumption reduction of the UE. With no traffic, the UE may perform the monitoring operation in the 20 MHz BWP, and transmit and receive data using the 100 MHz BWP according to an instruction of the eNode B if data occurs.

In the method for configuring the BWP, UEs before RRC connected may receive initial BWP configuration information through the MIB at the initial access. Specifically, the UE may be configured with a CORESET for a downlink control channel for transmitting DCI scheduling a system information block (SIB) from an MIB of a physical broadcast channel (PBCH). The bandwidth of the CORESET configured with the MIB may be regarded as the initial BWP, and the UE may receive a physical download shared channel (PDSCH) transmitting the SIB through the configured initial BWP. The initial BWP may be utilized for other system information (OSI), paging, and random access, besides the SIB reception.

[Bwp Changing]

If one or more BWPs are configured for the UE, the eNode B may instruct the UE to change (switch or transit) the BWP, using a BWP indicator field in the DCI. For example, if a currently activated BWP of the UE is the BWP #1 301 in FIG. 3, the eNode B may indicate the UE of the BWP #2 302 using the BWP indicator of the DCI, and the UE may change the BWP to the BWP #2 302 indicated by the BWP indicator of the received DCI.

As mentioned above, since the DCI based BWP change may be indicated by the DCI for scheduling the PDSCH or the PUSCH, the UE, if receiving a BWP change request, may need to receive and transmit without difficulty the PDSCH or the PUSCH scheduled by the corresponding DCI in the changed BWP. For doing so, the standard regulates requirements for a delay time T_{BWP} required in changing the BWP, and may be defined, for example, as shown in Table 3. Notably, the disclosure is not limited thereto.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
Note 2:
If the BWP switch involves changing of SCS, the BWP switch delay is determined by the larger one between the SCS before BWP switch and the SCS after BWP switch.

The requirements for the BWP change delay time supports the type 1 or the type 2 depending on the UE capability. The UE may report its supportable BWP delay time type to the eNode B.

According to the above-described requirements for the BWP change delay time, if the UE receives the DCI including the BWP change indicator in a slot n, the UE may complete changing to a new BWP indicated by the BWP change indicator at a timing not later than a slot n+T_{BWP}, and perform data channel transmission and reception scheduled by the corresponding DCI in the new changed BWP. If scheduling the data channel with the new BWP, the eNode B may determine time domain resource assignment for the data channel, by considering the BWP change delay time T_{BWP} of the UE. That is, if scheduling the data channel with the new BWP, the eNode B may schedule a corresponding data channel after the BWP change delay time, in the method for determining the time domain resource assignment for the data channel. Hence, the UE may not expect that the DCI indicating the BWP change indicates a slot offset value KO or K2 smaller than the BWP change delay time T_{BWP}.

If the UE receives the DCI (e.g., DCI format 1_1 or 0_1) indicating the BWP change, the UE may not perform any transmission or reception for a time duration from a third symbol of the slot receiving the PDCCH including the corresponding DCI, to a starting point of the slot indicated by the slot offset value KO or K2 indicated by the time domain resource assignment indicator field of the corresponding DCI. For example, if the UE receives the DCI indicating the BWP change in the slot n and the slot offset value indicated by the corresponding DCI is K, the UE may not perform any transmission or reception from the third symbol of the slot n to a symbol before a slot n+K (i.e., the last symbol of a slot n+K−1).

[Synchronization Signal (SS)/PBCH Block]

Next, a SS/PBCH block in the 5G is described.

The SS/PBCH block may indicate a physical layer channel block including a primary SS (PSS), a secondary SS (SSS), and a PBCH. Specifically, it is as follows:
PSS: It is a reference signal for downlink time/frequency synchronization, and provides some information of a cell ID;
SSS: It is a basis for downlink time/frequency synchronization, and provides remaining cell ID information not provided by the PSS. Additionally, it may serve as a reference signal for PBCH demodulation;
PBCH: It provides essential system information required for data channel and control channel transmission and reception of the UE. The essential system information may include search space related control information indicating radio resource mapping information of the control channel, scheduling control information of a separate data channel transmitting the system information, and the like, and
SS/PBCH block: The SS/PBCH block includes a combination of the PSS, the SSS, and the PBCH. One or more SS/PBCH blocks may be transmitted within a time of 5 ms, and each transmitted SS/PBCH block may be distinguished using an index.

The UE may detect the PSS and the SSS at the initial access, and decode the PBCH. The UE may acquire an MIB from the PBCH and thus may be configured with a CORESET #0 (corresponding to the CORESET having the index 0). The UE may assume that the selected SS/PBCH block and a demodulation reference signal (DMRS) transmitted in the CORESET #0 are quasi co-located (QCL) and perform monitoring on the CORESET #0. The UE may receive system information as downlink control information transmitted in the CORESET #0. The UE may obtain configuration information related to a random access channel (RACH) which is required for the initial access, from the received system information. The UE may transmit a physical RACH (PRACH) to the eNode B in consideration of the selected SS/PBCH index, and the eNode B receiving the PRACH may obtain information of the SS/PBCH block index selected by the UE. The eNode B may identify a block selected by the terminal from the SS/PBCH blocks and obtain that its associated CORESET #0 is monitored.

[Discontinuous Reception (DRX)]

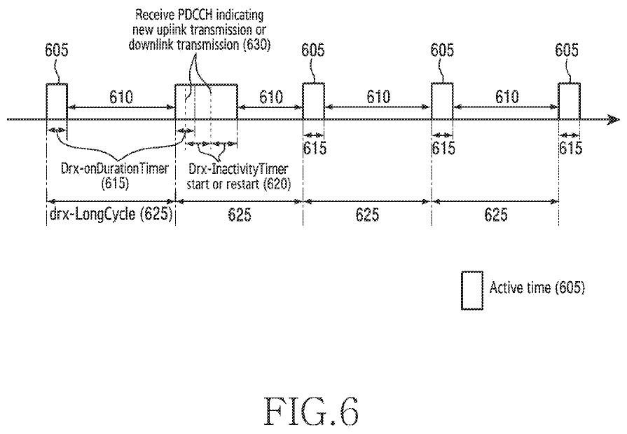

FIG. 6 illustrates an example of a DRX operation in a wireless communication system according to an embodiment of the present disclosure.

The DRX is an operation in which the UE using a service discontinuously receives data in an RRC connected state with a radio link established between the eNode B and the UE. If the DRX is applied, the UE may turn on a receiver at a specific time to monitor the control channel, and turn off the receiver to reduce its power consumption if there is no data received for a specific time. The DRX operation may be controlled by a media access control (MAC) device based on various parameters and timers.

Referring to FIG. 6, an active time 605 is a time for the UE to wake up every DRX cycle and monitor the PDCCH. The active time 605 may be defined as follows:
drx-onDurationTimer or drx-InactivityTimer or drx-RetransmissionTimerDL or drx-RetransmissionTimerUL or ra-ContentionResolutionTimer is running;
a Scheduling Request is sent on PUCCH and is pending; or
a PDCCH indicating a new transmission addressed to the C-RNTI of the MAC entity has not been received after successful reception of a random access response for the random access preamble not selected by the MAC entity among the contention-based random access preamble.

drx-onDurationTimer, drx-InactivityTimer, drx-RetransmissionTimerDL, drx-RetransmissionTimerUL, ra-ContentionResolutionTimer and so on are timers of which values are configured by the eNode B, and have a function of configuring the UE to monitor the PDCCH if a specific condition is satisfied.

drx-onDurationTimer 615 is a parameter for configuring a minimum time for which the UE is awake in the DRX cycle. drx-InactivityTimer 620 may be a parameter for configuring an additional time for which the UE is awake, if receiving a PDCCH 630 indicating new uplink transmission or downlink transmission. drx-RetransmissionTimerDL may be a parameter for configuring a maximum time for which the UE is awake to receive downlink retransmission in a downlink hybrid automatic repeat request (HARQ) procedure. drx-RetransmissionTimerUL may be a parameter for configuring a maximum time for which the UE is awake to receive an uplink retransmission grant in an uplink HARQ procedure. drx-onDurationTimer, the drx-InactivityTimer, the drx-RetransmissionTrmerDL, and the drx-RetransmissionTimerUL may be configured with, for example, time, the number of subframes, the number of slots, or the like. ra-ContentionResolutionTimer may be a parameter for monitoring the PDCCH in a random access procedure.

An inactive time 610 is a time configured not to monitor the PDCCH and/or a time configured not to receive the PDCCH during the DRX operation, and other time than the active time 605 in the total time of the DRX operation may be the inactive time 610. If not monitoring the PDCCH for the active time 605, the UE may enter a sleep or inactive state to reduce the power consumption.

The DRX cycle indicates a cycle for the UE to wake up and monitor the PDCCH. That is, the DRX cycle indicates a time interval from the PDCCH monitoring to next PDCCH monitoring of the UE or an on-duration cycle. The DRX cycle includes two types of a short DRX cycle and a long DRX cycle. The short DRX cycle may be applied optionally.

A long DRX cycle 625 may be a long cycle of the two DRX cycles configured in the UE. While operating in the long DRX, the UE restarts the drx-onDurationTimer 615 after the long DRX cycle 625 elapses from a start point (e.g., a start symbol) of the drx-onDurationTimer 615. If operating in the long DRX cycle 625, the UE may start the drx-onDurationTimer 615 in a slot after drx-SlotOffset in a subframe satisfying the following Equation 2. Herein, drx-SlotOffset indicates delay before the drx-onDurationTimer 615 starts. drx-SlotOffset may be configured with, for example, time, the number of slots, or the like.

[(SFN×10)+subframe number]modulo(drx−LongCycle)=drx−StartOffset. [Equation 1]

drx-LongCycleStartOffset may be used for the long DRX cycle 625 and drx-StartOffset may be used to define a subframe where the long DRX cycle 625 starts. drx-LongCycleStartOffset may be configured with, for example, time, the number of subframes, the number of slots, or the like.

[Pdcch: Dci Related]

Next, the DCI in the 5G system is described in detail.

In the 5G system, scheduling information of uplink data (or PUSCH) or downlink data (or PDSCH) may be transmitted from the eNode B to the UE through the DCI. The UE may monitor a fallback DCI format and a non-fallback DCI format with respect to the PUSCH or the PDSCH. The fallback DCI format may include a fixed field predefined between the eNode B and the UE, and the non-fallback DCI format may include a configurable field.

The DCI may be transmitted through the PDCCH after channel coding and modulation. Cyclic redundancy check (CRC) may be attached to a DCI message payload, and the CRC may be scrambled with a radio network temporary identifier (RNTI) corresponding to the identity of the UE. Different RNTIs may be used depending on a purpose of the DCI message, for example, UE-specific data transmission, power control command or random access response. That is, the RNTI is not explicitly transmitted but may be included and transmitted in CRC calculation. If receiving a DCI message transmitted on the PDCCH, the UE may identify the CRC using the allocated RNTI and obtain that the corresponding message is destined for the UE if the CRC result is correct.

For example, DCI for scheduling the PDSCH for the system information (SI) may be scrambled with an SI-RNTI. DCI for scheduling the PDSCH for a random access response (RAR) message may be scrambled with a random access (RA)-RNTI. DCI for scheduling the PDSCH for a paging message may be scrambled with a paging (P)-RNTI. DCI notifying a slot format indicator (SFI) may be scrambled with an SFI-RNTI. DCI notifying transmit power control (TPC) may be scrambled with a TPC-RNTI. DCI for scheduling a UE-specific PDSCH or PUSCH may be scrambled with a cell (C)-RNTI.

DCI format 0_0 may be used as the fallback DCI for scheduling the PUSCH, wherein the CRC may be scrambled with the C-RNTI. The DCI format 0_0 in which the CRC is scrambled with the C-RNTI may include, for example, the following information of Table 4. Notably, the disclosure is not limited thereto.

TABLE 4

| | |
|---|---|
| - | Identifier for DCI formats - [1] bit |
| - | Frequency domain resource assignment - |
| | [┌log₂(N_{RB}^{UL, BWP}(N_{RB}^{UL, BWP} +1)/2)┐ ] bits |
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | TPC command for scheduled PUSCH - [2] bits |
| - | UL/SUL (supplementary uplink) indicator - 0 or 1 bit |

DCI format 0_1 may be used as the non-fallback DCI for scheduling the PUSCH, wherein the CRC may be scrambled with the C-RNTI. The DCI format 0_1 in which the CRC is scrambled with the C-RNTI may include, for example, the following information of Table 5. Notably, the disclosure is not limited thereto.

TABLE 5

| - | Carrier indicator - 0 or 3 bits | |
|---|---|---|
| - | UL/SUL indicator - 0 or 1 bit | |
| - | Identifier for DCI formats - [1] bits | |
| - | Bandwidth part indicator - 0, 1 or 2 bits | |
| - | Frequency domain resource assignment | |
| | • | For resource allocation type 0, ┌N_{RB}^{UL,BWP}/P┐ bits |
| | • | For resource allocation type 1, [log₂(N_{RB}^{UL,BWP}(N_{RB}^{UL,BWP} +1)/2)┐ bits |

| | |
|---|---|
| - | Time domain resource assignment -1, 2, 3, or 4 bits |
| - | VRB-to-PRB mapping (virtual resource block-to-physical resource block mapping) - 0 |

or 1 bit, only for resource allocation type 1.

| | • | 0 bit if only resource allocation type 0 is configured; |
|---|---|---|
| | • | 1 bit otherwise. |
| - | Frequency hopping flag - 0 or 1 bit, only for resource allocation type 1. | |
| | • | 0 bit if only resource allocation type 0 is configured; |
| | • | 1 bit otherwise. |
| - | Modulation and coding scheme - 5 bits | |
| - | New data indicator - 1 bit | |
| - | Redundancy version - 2 bits | |
| - | HARQ process number - 4 bits | |
| - | 1st downlink assignment index- 1 or 2 bits | |
| | • | 1 bit for semi-static HARQ-ACK codebook; |
| | • | 2 bits for dynamic HARQ-ACK codebook with single HARQ-ACK codebook. |
| - | 2nd downlink assignment index - 0 or 2 bits | |
| | • | 2 bits for dynamic HARQ-ACK codebook with two HARQ-ACK sub- |
| | | codebooks; |
| | • | 0 bit otherwise. |
| - | TPC command for scheduled PUSCH - 2 bits | |
| - | $SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$ | |
| | • | $⌈ {log}_{2} ( {\sum }_{k = 1}^{{L}_{max}} ( \begin{matrix}{N}_{SRS} \\ k\end{matrix} ) ) ⌉ bits for non - codebook based PUSCH transmission ;$ |
| | • | ┌log₂(N_{SRS})┐ bits for codebook based PUSCH transmission. |

| | |
|---|---|
| - | Precoding information and number of layers-up to 6 bits |
| - | Antenna ports- up to 5 bits |
| - | SRS request - 2 bits |
| - | CSI request - 0, 1, 2, 3, 4, 5, or 6 bits |
| - | CBG transmission information- 0, 2, 4, 6, or 8 bits |
| - | PTRS-DMRS association- 0 or 2 bits. |
| - | beta_offset indicator- 0 or 2 bits |
| - | DMRS sequence initialization- 0 or 1 bit |

DCI format 1_0 may be used as the fallback DCI for scheduling the PDSCH, wherein the CRC may be scrambled with the C-RNTI. The DCI format 1_0 in which the CRC is scrambled with the C-RNTI may include, for example, but not limited to, the following information of Table 6.

TABLE 6

| | |
|---|---|
| - | Identifier for DCI formats - [1] bit |
| - | Frequency domain resource |
| | assignment -[┌log₂(N_{RB}^{DL, BWP}(N_{RB}^{DL, BWP} +1)/2)┐ ] bits |
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | PUCCH resource indicator- 3 bits |
| - | PDSCH-to-HARQ feedback timing indicator- [3] bits |

DCI format 1_1 may be used as the non-fallback DCI for scheduling the PDSCH, wherein the CRC may be scrambled with the C-RNTI. The DCI format 1_1 in which the CRC is scrambled with the C-RNTI may include, for example, but not limited to, the following information of Table 7.

TABLE 7

| | |
|---|---|
| - | Carrier indicator - 0 or 3 bits |
| - | Identifier for DCI formats - [1] bits |
| - | Bandwidth part indicator - 0, 1 or 2 bits |
| - | Frequency domain resource assignment |

• For resource allocation type 0, ┌N_{RB}^{DL, BWP} / P┐ bits
• For resource allocation type 1,
┌log₂(N_{RB}^{DL, BWP}(N_{RB}^{DL, BWP} +1)/2)┐ bits

| | |
|---|---|
| - | Time domain resource assignment -1, 2, 3, or 4 bits |
| - | VRB-to-PRB mapping - 0 or 1 bit, only for resource allocation |
| | type 1. |

• 0 bit if only resource allocation type 0 is configured;
• 1 bit otherwise.

| | |
|---|---|
| - | PRB bundling size indicator - 0 or 1 bit |
| - | Rate matching indicator - 0, 1, or 2 bits |
| - | ZP CSI-RS trigger - 0, 1, or 2 bits |

For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

[PDCCH: CORESET, Resource Element Group (REG), Control Channel Element (CCE), Search Space]

A downlink control channel in the 5G communication system is described in more detail with reference to the drawings.

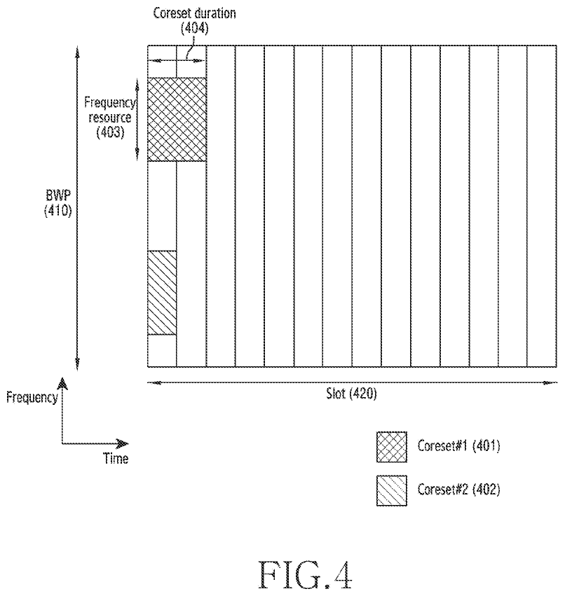

FIG. 4 illustrates an example of a CORESET configuration of a downlink control channel in a wireless communication system according to an embodiment of the present disclosure.

FIG. 4 illustrates the example in which a UE BWP 410 on the frequency axis, and two CORESETs (a CORESET #1 401, a CORESET #2 402) in one slot 420 on the time axis are configured. The CORESETs 401 and 402 may be configured in a specific frequency resource 403 within the whole UE BWP 410 on the frequency axis. One or more OFDM symbols may be configured on the time axis, which may be defined as a CORESET duration 404. Referring to the example shown in FIG. 4, The CORESET #1 401 is set to the CORESET duration of two symbols, and the CORESET #2 402 is set to the CORESET duration of one symbol.

The CORESET in the 5G may be configured through higher layer signaling (e.g., SI, MIB, RRC signaling) from the eNode B to the UE. Configuring the CORESET for the UE indicates providing information such as CORESET identity, CORESET frequency location, and CORESET symbol duration. For example, the CORESET may include the following information.

TABLE 8

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |
| frequencyDomainResources | BIT STRING (SIZE (45)), |
| duration | INTEGER (1..maxCoReSetDuration), |
| cce-REG-MappingType | CHOICE { |
| interleaved | SEQUENCE { |
| reg-BundleSize | ENUMERATED {n2, n3, n6}, |
| precoderGranularity | ENUMERATED {sameAsREG-bundle, |
| allContiguousRBs}, | |
| interleaverSize | ENUMERATED {n2, n3, n6} |
| shiftIndex | |

INTEGER(0..maxNrofPhysicalResourceBlocks-1)

| | |
|---|---|
| OPTIONAL | |
| }, | |
| nonInterleaved | NULL |
| }, | |
| tci-StatesPDCCH | SEQUENCE(SIZE (1..maxNrofTCI- |
| StatesPDCCH)) OF TCI-StateId | OPTIONAL, |
| tci-PresentInDCI | ENUMERATED |
| {enabled} | OPTIONAL, -- |
| Need S | |
| } | |

In Table 8, tci-StatesPDCCH (simply referred to as a TCI state) configuration information may include information of one or more SS/PBCH block indexes or channel state information reference signal (CSI-RS) indexes which are quasi co-located with a DMRS transmitted in the corresponding CORESET. Notably, Table 8 is merely the example, and the disclosure is not limited thereto.

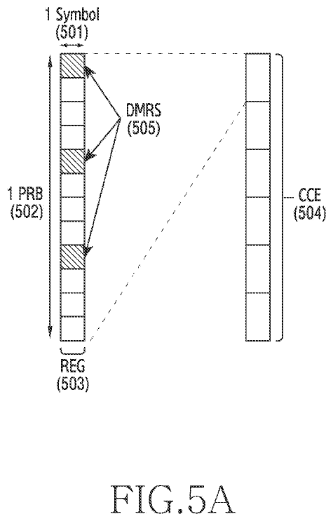

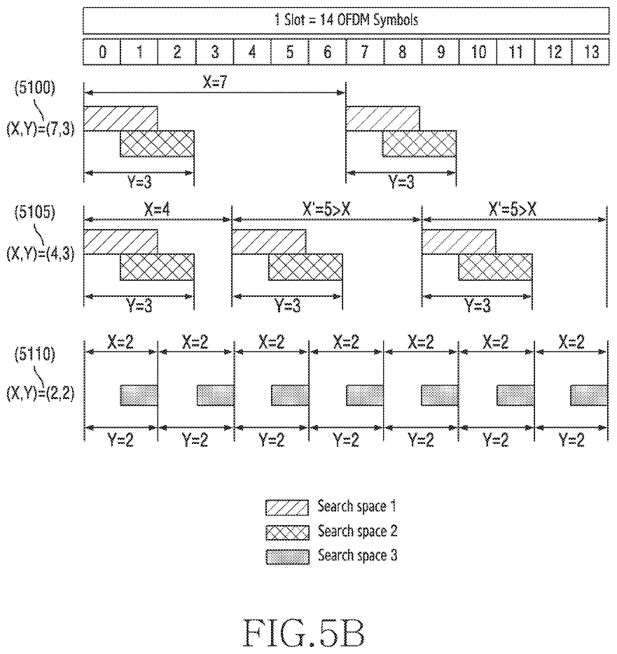

FIG. 5A illustrates a downlink control channel structure in a wireless communication system according to an embodiment of the present disclosure. According to FIG. 5A, the basic unit of the time and frequency resources constituting the control channel may be referred to as a REG 503, and the REG 503 may be defined as one OFDM symbol 501 on the time axis and one physical resource block (PRB) 502, that is, as 12 subcarriers on the frequency axis. The eNode B may configure a downlink control channel allocation unit by concatenating the REG 503.

If the basic unit for allocating the downlink control channel in the 5G is a CCE 504 as shown in FIG. 5A, one CCE 504 may include a plurality of REGs 503. For example, the REG 503 shown in FIG. 5A may include 12 REs, and if one CCE 504 includes six REGs 503, one CCE 504 may include 72 REs. If the DL CORESET is configured, the corresponding CORESET may include a plurality of CCEs 504, and a specific DL CORESET may be mapped to one or more CCEs 504 according to an aggregation level (AL) in the CORESET and then transmitted. The CCEs 504 in the CORESET may be distinguished by their number, and the numbers of the CCEs 504 may be given in a logical mapping manner.

The basic unit of the DL CORESET shown in FIG. 5A, that is, the REG 503, may include both the REs to which DCI is mapped and an area to which a DMRS 505 being a reference signal for decoding the DCI is mapped. As shown in FIG. 5A, three DMRSs 505 may be transmitted in one REG 503. The number of CCEs required to transmit the PDCCH may be 1, 2, 4, 8, or 16 depending on the AL, and the different numbers of CCEs may be used to implement link adaptation of the downlink control channel. For example, if AL=L, one downlink control channel may be transmitted through L CCEs. The UE needs to detect a signal without knowing downlink control channel information, and a search space indicating a set of CCEs for blind decoding is defined. The search space is a set of downlink control channel candidates including CCEs which the UE may attempt to decode on a given AL, and the UE may have a plurality of search spaces because there are various Als making one bundle from 1, 2, 4, 8, or 16 CCEs. A search space set may be defined as a set of search spaces at any configured AL.

The search spaces may be classified into a common search space and a UE-specific search space. UEs of a specific group or all UEs may monitor the common search space of the PDCCH to receive dynamic scheduling of SI or cell-common control information such as a paging message. For example, PDSCH scheduling allocation information for SIB transmission including cell operator information may be received by monitoring the common search space of the PDCCH. Since UEs of a specific group or all UEs may receive the PDCCH, the common search space may be defined as a set of predefined CCEs. The scheduling allocation information of the UE-specific PDSCH or the PUSCH may be received by monitoring the UE-specific search space of the PDCCH. The UE-specific search space may be UE-specifically defined with a function of the UE identity and various system parameters.

In the 5G, parameters of the search space for the PDCCH may be configured by the eNode B for the UE using higher layer signaling (e.g., SIB, MIB, or RRC signaling). For example, the base station may configure for the UE the number of PDCCH candidates of each AL L, monitoring periodicity of the search space, a symbol-level monitoring occasion within the slot for the search space, a search space type (the common search space or the UE-specific search space), a combination of the DCI format and the RNTI to monitor the search space, a CORESET index for monitoring the search space, and the like. For example, it may include, but not limited to, the following information.

TABLE 9

| | |
|---|---|
| SearchSpace ::= | SEQUENCE { |

-- Identity of the search space. SearchSpaceId = 0 identifies the SearchSpace configured via
PBCH (MIB) or ServingCellConfigCommon.

| | |
|---|---|
| searchSpaceId | SearchSpaceId, |
| controlResourceSetId | ControlResourceSetId, |
| monitoringSlotPeriodicity AndOffset | CHOICE { |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |
| } | |

OPTIONAL,

| | |
|---|---|
| duration | INTEGER (2..2559) |

| | |
|---|---|
| monitoringSymbolsWithinSlot | BIT STRING (SIZE (14)) |

OPTIONAL,

| | |
|---|---|
| nrofCandidates | SEQUENCE { |
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED (n0, n1, n2, n3, n4, 5, n6, n8}, |
| aggregationLevel8 | ENUMERATED {n0, n1, n2, n3, n4, n5, n6, 08}, |
| aggregationLevel16 | ENUMERATED {n0, n1, n2, n3, n4, n5, n6, |
| n8} | |
| }, | |
| searchSpaceType | CHOICE { |

-- Configures this search space as common search space (CSS) and DCI formats to monitor.

| | |
|---|---|
| Common | SEQUENCE { |
| } | |
| ue-Specific | SEQUENCE { |

-- Indicates whether the UE monitors in this USS for DCI formats 0-0 and 1-0 or for

| | |
|---|---|
| formats 0-1 and 1-1. | |
| Formats | ENUMERATED {formats0-0-And-1-0, |
| formats0-1-And-1-1}, | |
| ... | |
| } | |

The eNode B may configure one or more search space sets for the UE based on the configuration information. According to an embodiment, the eNode B may configure a search space set 1 and a search space set 2 for the UE, configure to monitor a DCI format A scrambled with an X-RNTI in the search space set 1 in the common search space, and configure to monitor a DCI format B scrambled with a Y-RNTI in the search space set 2 in the UE-specific search space.

According to the configuration information, the common search space or the UE-specific search space may include one or more search space sets. For example, a search space set #1 and a search space set #2 may be configured as the common search space, and a search space set #3 and a search space set #4 may be configured as the UE-specific search space.

The following combinations of DCI formats and RNTIs may be monitored in the common search space. Notably, the disclosure is not limited thereto:
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_1 with CRC scrambled by INT-RNTI;
DCI format 2_2 with CRC scrambled by TPC-PUSCH-RNTI, TPC-PUCCH-RNTI; and
DCI format 2_3 with CRC scrambled by TPC-SRS-RNTI.

In the UE-specific search space, the following combinations of DCI formats and RNTIs may be monitored. Notably, the disclosure is not limited thereto:
DCI format 0_0/1_0 with CRC scrambled by C-RNTI, CS-RNTI, TC-RNTI; and
DCI format 1_0/1_1 with CRC scrambled by C-RNTI, CS-RNTI, TC-RNTI.

The specified RNTIs may follow definitions and usages as below:
Cell RNTI (C-RNTI): for scheduling the UE-specific PDSCH;
Temporary cell RNTI (TC-RNTI): for scheduling the UE-specific PDSCH;
Configured scheduling RNTI (CS-RNTI): for scheduling UE-specific PDSCH semi-statically configured;
Random access RNTI (RA-RNTI): for scheduling the PDSCH at random access stage;
Paging RNTI (P-RNTI): for scheduling the PDSCH which transmits paging;
System information RNTI (SI-RNTI): for scheduling the PDSCH which transmits SI;
Interruption RNTI (INT-RNTI): for notifying PDSCH puncturing;
Transmit power control for PUSCH RNTI (TPC-PUSCH-RNTI): for indicating power control command for the PUSCH;
Transmit power control for PUCCH RNTI (TPC-PUCCH-RNTI): for indicating power control command for the PUCCH; and
Transmit power control for SRS RNTI (TPC-SRS-RNTI): for indicating power control command for the SRS.

The above-specified DCI formats may follow the definitions as below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH and |
| | PUSCH |
| 2_3 | Transmission of a group of TPC commands for |
| | SRS transmissions by one or more UEs |

In the 5G, the search space of the AL L in a CORESET p and a search space set s may be expressed as the following Equation 2.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad [ Equation 2 ]$$

L: AL;
n_{CI}: carrier index;
N_{CCE,p}: the total number of CCEs in the CORESET p;
n_{s,f}^{μ}: slot index,
M_{s,max}^{(L)}: x the number of PDCCH candidates of the AL L;
m_{s,n}_{_{CI}}=0, . . . , M_{s,max}^{(L)}−1: PDCCH candidate index of the AL L;
i=0, . . . , L−1;

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, A=39827 for pmod3=0, Aₚ=39829 for pmod3=1, Aₚ=39839 for pmod3=2, D=65537; and
n_{RNTI}: UE ID.

The value Y_{p,n}_{_{s,f}}_{^{μ}} may correspond to 0 in the common search space.

The value Y_{p,n}_{_{s,f}}_{^{μ}} may correspond to a value which varies depending on the UE identity (C-RNTI or an ID set to the UE by the eNode B) and a time index, in the UE-specific search space.

In the 5G, as a plurality of search space sets may be configured with different parameters (e.g., the parameters of Table 9), a set of search space sets monitored by the UE may differ at each time. For example, if a search space set #1 is configured with an X-slot periodicity, a search space set #2 is configured with a Y-slot periodicity, and X and Y are different, the UE may monitor both the search space set #1 and the search space set #2 in a specific slot, and monitor one of the search space set #1 and the search space set #2 in a specific slot.

[Pdcch: Span]

The UE may perform UE capability report in each subcarrier spacing if having a plurality of PDCCH monitoring occasions in the slot, wherein the concept of the span may be used. The span indicates consecutive symbols for the UE to monitor the PDCCH in the slot, and each PDCCH monitoring occasion is within one span. The span may be expressed as (X, Y), where X denotes the minimum number of symbols between first symbols of two consecutive spans, and Y denotes the number of consecutive symbols for monitoring the PDCCH within one span. At this time, the UE may monitor the PDCCH in a duration of Y symbols from the first symbol of the span in the span.

FIG. 5B illustrates a span that the UE may have a plurality of PDCCH monitoring occasions within a slot in the wireless communication system according to an embodiment of the present disclosure. For example, as shown in FIG. 5B, the span (X, Y)=(7, 3), (4, 3), and (2, 2) are e possible, which are represented as 5100, 5105 and 5110 respectively. For example, 5100 represents two spans expressed as (7, 4) in the slot. The spacing between first symbols of the two spans is expressed as X=7, PDCCH monitoring occasions may exist within Y=3 symbols in total from the first symbol of each span, and search spaces 1 and 2 exist within Y=3 symbols. As another example, the span 5105 represents three spans in total expressed as (4, 3) in the slot, and the spacing between second and third spans is X′=5 symbols greater than X=4.

[PDCCH: UE Capability Report]

The slot position of the above-described common search space and UE-specific search space is indicated by a parameter monitoringSymbolsWithinSlot of Table 11, and the symbol position in the slot is indicated by a bitmap through the parameter monitoringSymbolsWithinSlot of Table 9. Meanwhile, the symbol position allowing the UE to monitor the search space within the slot may be reported to the eNode B through the following examples of UE capabilities.

In one example of UE capability 1 (hereafter used interchangeably with FG 3-1): The UE capability 1 indicates, if one monitoring occasion (MO) for type 1 and type 3 common search spaces or UE-specific search spaces exists in the slot, capability for monitoring the corresponding MO if the corresponding MO is positioned in first three symbols in the slot as shown in the following Table 11. The UE capability 1 is mandatory capability to be supported by every UE supporting the NR and whether or not to support the UE capability 1 may not be explicitly reported to the eNode B.

TABLE 11-1

| | Feature | | Field name in |
|---|---|---|---|
| Index | group | Components | TS 38.331 |
| 3-1 | Basic DL | 1) One configured CORESET per BWP per cell in | n/a |
| | control | addition to CORESET0 | |
| | channel | CORESET resource allocation of 6RB bit-map and | |
| | | duration of 1-3 OFDM symbols for FR1 | |
| | | For type 1 CSS without dedicated RRC | |
| | | configuration and for type 0, 0A, and 2 CSSs, | |
| | | CORESET resource allocation of 6RB bit-map and | |
| | | duration 1-3 OFDM symbols for FR2 | |
| | | For type 1 CSS with dedicated RRC configuration | |
| | | and for type 3 CSS, UE specific SS, CORESET | |
| | | resource allocation of 6RB bit-map and duration 1-2 | |
| | | OFDM symbols for FR2 | |
| | | REG-bundle sizes of 2/3 RBs or 6 RBs | |
| | | Interleaved and non-interleaved CCE-to-REG | |
| | | mapping | |
| | | Precoder-granularity of REG-bundle size | |
| | | PDCCH DMRS scrambling determination | |
| | | TCI state(s) for a CORESET configuration | |
| | | 2) CSS and UE-SS configurations for unicast | |
| | | PDCCH transmission per BWP per cell | |
| | | PDCCH aggregation levels 1, 2, 4, 8, 16 | |
| | | UP to 3 search space sets in a slot for a scheduled | |
| | | SCell per BWP | |
| | | This search space limit is before applying all | |
| | | dropping rules. | |
| | | For type 1 CSS with dedicated RRC configuration, | |
| | | type 3 CSS, and UE-SS, the monitoring occasion is | |
| | | within the first 3 OFDM symbols of a slot | |
| | | For type 1 CSS without dedicated RRC | |
| | | configuration and for type 0, 0A, and 2 CSS, the | |
| | | monitoring occasion can be any OFDM symbol(s) of | |
| | | a slot, with the monitoring occasions for any of Type | |
| | | 1- CSS without dedicated RRC configuration, or | |
| | | Types 0, 0A, or 2 CSS configurations within a single | |
| | | span of three consecutive OFDM symbols within a | |
| | | slot | |
| | | 3) Monitoring DCI formats 0_0, 1_0, 0_1, 1_1 | |
| | | 4) Number of PDCCH blind decodes per slot with a | |
| | | given SCS follows Case 1-1 table | |
| | | 5) Processing one unicast DCI scheduling DL and | |
| | | one unicast DCI scheduling UL per slot per | |
| | | scheduled CC for FDD | |
| | | 6) Processing one unicast DCI scheduling DL and 2 | |
| | | unicast DCI scheduling UL per slot per scheduled | |
| | | CC for TDD | |

In one example of UE capability 2 (hereafter used interchangeably with FG 3-2): The UE capability 2 indicates, if one MO for the common search space or the UE-specific search space exists in the slot, capability for monitoring the MO regardless of a start symbol position of the corresponding MO as shown in the following Table 11-2. The UE capability 2 is optionally supported by the UE, and whether to support the UE capability 2 may be explicitly reported to the eNode B. However, the disclosure is not limited thereto.

TABLE 11-2

| Index | Feature group | Components | Field name in TS 38.331 |
|---|---|---|---|
| 3-2 | PDCCH | For a given UE, all search | pdcchMonitoringSingleOccasion |
| | monitoring on any | space configurations are | |
| | span of up to 3 | within the same span of 3 | |
| | consecutive OFDM | consecutive OFDM | |
| | symbols of a slot | symbols in the slot | |

In one example of UE capability 3 (hereafter used interchangeably with FG 3-5, 3-5a, or 3-5b): The UE capability 3 indicates, if a plurality of MOs for the common search space or the UE-specific search space exists in the slot, a MO pattern for the UE to monitor, as shown in the following Table 11-3. The above pattern may include the start symbol spacing X between different MOs and a maximum symbol length Y for one MO. A combination of (X, Y) supported by the UE may include one or more of {(2, 2), (4, 3), (7, 3)}. The UE capability 3 is optionally supported by the UE, and whether to support the UE capability 3 and the above-mentioned combination (X, Y) may be explicitly reported to the eNode B. However, the disclosure is not limited thereto.

TABLE 11-3

| Index | Feature group | Components | Field name in TS 38.331 |
|---|---|---|---|
| 3-5 | For type 1 CSS | For type 1 CSS with dedicated RRC | pdcch- |
| | with dedicated | configuration, type 3 CSS, and UE- | Monitoring AnyOccasions |
| | RRC configuration, | SS, monitoring occasion can be any | { |
| | type 3 CSS, and | OFDM symbol(s) of a slot for Case | 3-5. withoutDCI-Gap |
| | UE-SS, monitoring | 2 | 3-5a. withDCI-Gap |
| | occasion can be | | } |
| | any OFDM | | |
| | symbol(s) of a slot | | |
| | for Case 2 | | |
| 3-5a | For type 1 CSS | For type 1 CSS with dedicated RRC | |
| | with dedicated | configuration, type 3 CSS and UE- | |
| | RRC configuration, | SS, monitoring occasion can be any | |
| | type 3 CSS, and | OFDM symbol(s) of a slot for Case | |
| | UE-SS, monitoring | 2, with minimum time separation | |
| | occasion can be | (including the cross-slot boundary | |
| | any OFDM | case) between two DL unicast DCIs, | |
| | symbol(s) of a slot | between two UL unicast DCIs, or | |
| | for Case 2 with a | between a DL and an UL unicast | |
| | DCI gap | DCI in different monitoring | |
| | | occasions where at least one of them | |
| | | is not the monitoring occasions of | |
| | | FG-3-1, for a same UE as | |
| | | 2OFDM symbols for 15 kHz | |
| | | 4OFDM symbols for 30 kHz | |
| | | 7OFDM symbols for 60 kHz | |
| | | with NCP | |
| | | 11OFDM symbols for | |
| | | 120 kHz | |
| | | Up to one unicast DL DCI and up to | |
| | | one unicast UL DCI in a monitoring | |
| | | occasion except for the monitoring | |
| | | occasions of FG 3-1. | |
| | | In addition for TDD the minimum | |
| | | separation between the first two UL | |
| | | unicast DCIs within the first 3 | |
| | | OFDM symbols of a slot can be zero | |
| | | OFDM symbols. | |
| 3-5b | All PDCCH | PDCCH monitoring occasions of | |
| | monitoring | FG-3-1, plus additional PDCCH | |
| | occasion can be | monitoring occasion(s) can be any | |
| | any OFDM | OFDM symbol(s) of a slot for Case | |
| | symbol(s) of a slot | 2, and for any two PDCCH | |
| | for Case 2 with a | monitoring occasions belonging to | |
| | span gap | different spans, where at least one of | |
| | | them is not the monitoring occasions | |
| | | of FG-3-1, in same or different | |
| | | search spaces, there is a minimum | |
| | | time separation of X OFDM | |
| | | symbols (including the cross-slot | |
| | | boundary case) between the start of | |
| | | two spans, where each span is of | |
| | | length up to Y consecutive OFDM | |
| | | symbols of a slot. Spans do not | |
| | | overlap. Every span is contained in a | |
| | | single slot. The same span pattern | |
| | | repeats in every slot. The separation | |
| | | between consecutive spans within | |
| | | and across slots may be unequal but | |
| | | the same (X, Y) limit may be | |
| | | satisfied by all spans. Every | |
| | | monitoring occasion is fully | |
| | | contained in one span. In order to | |
| | | determine a suitable span pattern, | |
| | | first a bitmap b(l), 0 <= l <= 13 is | |
| | | generated, where b(l) = 1 if symbol l | |
| | | of any slot is part of a monitoring | |
| | | occasion, b(l) = 0 otherwise. The first | |
| | | span in the span pattern begins at the | |
| | | smallest l for which b(l) = 1. The next | |
| | | span in the span pattern begins at the | |
| | | smallest l not included in the | |
| | | previous span(s) for which b(l) = 1. | |
| | | The span duration is max{maximum | |
| | | value of all CORESET durations, | |
| | | minimum value of Y in the UE | |
| | | reported candidate value} except | |
| | | possibly the last span in a slot which | |
| | | can be of shorter duration. A | |
| | | particular PDCCH monitoring | |
| | | configuration meets the UE | |
| | | capability limitation if the span | |
| | | arrangement satisfies the gap | |
| | | separation for at least one (X, Y) in | |
| | | the UE reported candidate value set | |
| | | in every slot, including cross slot | |
| | | boundary. | |
| | | For the set of monitoring occasions | |
| | | which are within the same span: | |
| | | Processing one unicast DCI | |
| | | scheduling DL and one unicast DCI | |
| | | scheduling UL per scheduled CC | |
| | | across this set of monitoring | |
| | | occasions for FDD | |
| | | Processing one unicast DCI | |
| | | scheduling DL and two unicast DCI | |
| | | scheduling UL per scheduled CC | |
| | | across this set of monitoring | |
| | | occasions for TDD | |
| | | Processing two unicast DCI | |
| | | scheduling DL and one unicast DCI | |
| | | scheduling UL per scheduled CC | |
| | | across this set of monitoring | |
| | | occasions for TDD | |
| | | The number of different start | |
| | | symbol indices of spans for all | |
| | | PDCCH monitoring occasions per | |
| | | slot, including PDCCH monitoring | |
| | | occasions of FG-3-1, is no more | |
| | | than floor(14/X) (X is minimum | |
| | | among values reported by UE). | |
| | | The number of different start | |
| | | symbol indices of PDCCH | |
| | | monitoring occasions per slot | |
| | | including PDCCH monitoring | |
| | | occasions of FG-3-1, is no more | |
| | | than 7. | |
| | | The number of different start | |
| | | symbol indices of PDCCH | |
| | | monitoring occasions per half-slot | |
| | | including PDCCH monitoring | |
| | | occasions of FG-3-1 is no more than | |
| | | 4 in SCell. | |

The UE may report whether to support the UE capability 2 and/or the UE capability 3 and related parameters to the eNode B. The eNode B may perform time domain resource allocation for the common search space and the UE-specific search space based on the reported UE capability. In the resource allocation, the eNode B may not locate the MO at a position not monitored by the UE.

[Pdcch: Bd/Cce Limit]

If a plurality of search space sets is configured in the UE, the following conditions may be considered in a method for determining a search space set to be monitored by the UE.

If the UE is configured with a value monitoringCapabilityConfig-r16 which is higher layer signaling, as r15monitoringcapability, the UE may define maximum values of the number of PDCCH candidates to monitor and the number of CCEs constituting the entire search space (herein, the entire search space indicates an entire CCE set corresponding to a union area of a plurality of search space sets) for each slot, and if the value monitoringCapabilityConfig-r16 is configured as r16monitoringcapability, the UE may define maximum values of the number of the PDCCH candidates to monitor and the number of the CCEs constituting the entire search space (herein, the entire search space indicates the entire CCE set corresponding to the union area of the plurality of the search space sets) for each span.

[Condition 1: Limit the Maximum Number of PDCCH Candidates]

According to the higher layer signaling configuration value, M^{μ} which is the maximum number of the PDCCH candidates for the UE to monitor may follow Table 12-1 as below if it is defined based on the slot, and may follow Table 12-2 below if it is defined based on the span, in a cell with the subcarrier spacing 15·2^{μ} kHz.

TABLE 12-1

| | Maximum number of PDCCH candidates per |
|---|---|
| μ | slot and per serving cell (M^{μ}) |
| 0 | 44 |
| 1 | 36 |
| 2 | 22 |
| 3 | 20 |

TABLE 12-2

| | Maximum number M^{μ} of monitored PDCCH | | |
|---|---|---|---|
| | candidates per span for combination (X, Y) | | |
| | and per serving cell | | |
| μ | (2, 2) | (4, 3) | (7, 3) |
| 0 | 14 | 28 | 44 |
| 1 | 12 | 24 | 36 |

[Condition 2: Limit the Maximum Number of CCEs]

According to the higher layer signaling configuration value, C^{μ} which is the maximum number of the CCEs constituting the entire search space (herein, the entire search space indicates the entire CCE set corresponding to the union area of the plurality of the search space sets) may following Table 12-3 below if it is defined based on the slot, and may follow Table 12-4 below if it is defined based on the span, in the cell having the subcarrier spacing 15·2^{μ} kHz.

TABLE 12-3

| | Maximum number of non-overlapped CCEs per slot |
|---|---|
| μ | and per serving cell (C^{μ}) |
| 0 | 56 |
| 1 | 56 |
| 2 | 48 |
| 3 | 32 |

TABLE 12-4

| | Maximum number C^{μ} of non-overlapped | | |
|---|---|---|---|
| | CCEs per span for combination (X, Y) and | | |
| | per serving cell | | |
| μ | (2, 2) | (4, 3) | (7, 3) |
| 0 | 18 | 36 | 56 |
| 1 | 18 | 36 | 56 |

To ease the explanation, a situation satisfying both the conditions 1 and 2 at a specific time is defined as a “condition A.” Accordingly, not satisfying the condition A may indicate not satisfying at least one of the conditions 1 and 2.

[PDCCH: Overbooking]

The condition A may not be satisfied at a specific time depending on the configuration of the search space sets of the eNode B. If the condition A is not satisfied at the specific time, the UE may select and monitor only some of the search space sets configured to satisfy the condition A at the corresponding time, and the eNode B may transmit the PDCCH in the selected search space set.

Selecting some search spaces from the configured search space sets may conform to the following methods.

If the condition A for the PDCCH is not satisfied at the specific time (slot), the UE (or the eNode B) may first select the search space set in which the search space type is configured as the common search space among the search space sets existing at the corresponding time, over the search space set which is configured as the UE-specific search space.

If all the search space sets configured as the common search space are selected (i.e., if the condition A is satisfied even after selecting all the search spaces configured as the common search space), the UE (or the eNode B) may select the search space sets configured as the UE-specific search space. In this case, if a plurality of search space sets is configured as the UE-specific search space, the search space set having a low search space set index may have high priority. The UE-specific search space sets may be selected within a range satisfying the condition A in consideration of the priority.

[Qcl, Tci State]

In the wireless communication system, one or more different antenna ports (may be replaced with one or more channels, signals, and a combination thereof but may be collectively referred to as different antenna ports to ease the description of the disclosure below) may be associated with each other by QCL configuration as shown in the following [Table 18]. The TCI state is to notify the QCL relationship between the PDCCH (or PDCCH DMRS) and other RS or channel, and QCL of a specific reference antenna port A (a reference RS #A) and another target antenna port B (a target RS #B) may indicate that the UE is allowed to apply some or all of large-scale channel parameters estimated from the antenna port A to channel measurement from the antenna port B. The QCL may need to associate different parameters depending on a situation such as 1) time tracking affected by average delay and delay spread, 2) frequency tracking affected by Doppler shift and Doppler spread, 3) radio resource management (RRM) affected by average gain, or 4) beam management (BM) affected by a spatial parameter. Hence, the NR may support four QCL relationship types as shown in the following Table 13.

TABLE 13

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Rx parameter |

Spatial RX parameters may refer to some or all of various parameters such as angle of arrival (AoA), power angular-spectrum (PAS) of AoA, angle of departure (AoD), PAS of AoD, transmit/receive channel correlation, transmit/receive beamforming, and spatial channel correlation.

The QCL relationship may be configured for the UE through an RRC parameter TCI state and QC-information as shown in the following Table 14. Referring to Table 14, the eNode B may configure one or more TCI states for the UE and thus notify of up to two QCL relationships qcl-Type1 and qcl-Type2 of the RS referring to the ID of the TCI state, that is, a target RS. At this time, each QCL information included in each TCI state may include a serving cell index and a B % FP index of the reference RS indicated by the corresponding QCL information, type and ID of the reference RS, and the QCL type shown in Table 13.

| | |
|---|---|
| TCI-State ::= | SEQUENCE { |
| tci-StateId | TCI-StateId, |
| qcl-Type1 | QCL-Info, |
| qcl-Type2 | QCL-Info OPTIONAL, -- |
| Need R | |
| ... | |
| } | |
| QCL-Info := | SEQUENCE { |
| cell | ServCellIndex OPTIONAL, -- Need |
| R | |
| bwp-Id | BWP-Id OPTIONAL, -- |
| Cond CSI-RS-Indicated | |
| referenceSignal | CHOICE { |
| csi-rs | NZP-CSI-RS-ResourceId, |
| ssb | SSB-Index |
| }, | |
| qcl-Type | ENUMERATED {typeA, typeB, typeC, typeD}, |
| ... | |
| } | |

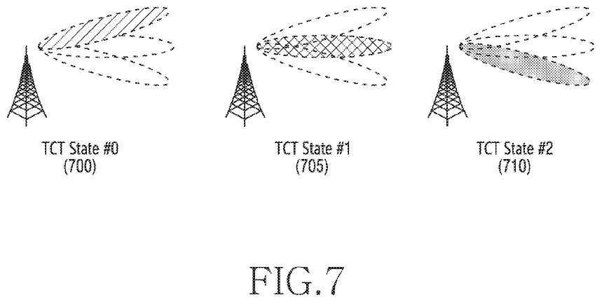

FIG. 7 illustrates an example of base station beam allocation according to TCI state configuration in a wireless communication system according to an embodiment of the present disclosure. Referring to FIG. 7, the base station may transmit information of N different beams to the terminal through N different TCI states. For example, if N=3 as shown in FIG. 7, the base station may configure a parameter qcl-Type2 included in three TCI states 700, 705, and 710 to be associated with CSI-RSs or SSBs corresponding to different beams, configure as a QCL type D and thus notify that antenna ports referring to the different TCI states 700, 705, and 710 are associated with different spatial Rx parameters, that is, different beams.

The following Tables 15-1 through 15-5 show valid TCI state configurations based on target antenna port types.

Table 15-1 shows valid TCI state configurations if the target antenna port is CSI-RS for tracking (TRS). The TRS indicates non-zero-power (NZP) CSI-RS in which the repetition parameter is not configured and trs-Info is set to true in the CSI-RS. The third configuration in Table 15-1 may be used for aperiodic TRS. The disclosure is not limited thereto.

TABLE 15-1
Valid TCI state configurations if the target antenna port is TRS

| Valid TCI | | | | qcl-Type2 |
|---|---|---|---|---|
| state | | | DL RS 2 | (if |
| Configuration | DL RS 1 | qcl-Type1 | (if configured] | configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same as | QCL-TypeD |
| | (periodic) | | DL RS 1) | |

Table 15-2 shows valid TCI state configurations if the target antenna port is CSI-RS for CSI. The CSI-RS for CSI indicates NZP CSI-RS in which a parameter indicating the repetition (e.g., a repetition parameter) is not configured and trs-Info is not set as true in the CSI-RS. The disclosure is not limited thereto.

TABLE 15-2
Valid TCI state configurations if the
target antenna port is CRS-RS for CSI

| Valid TCI | | | | |
|---|---|---|---|---|
| state | DL | | DL RS 2; | qcl-Type2 |
| Configuration | RS 1 | qcl-Type1 | (if configured) | (if configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS (same as | QCL-TypeD |
| | | | DL RS 1) | |
| 4 | TRS | QCL-TypeB | | |

Table 15-3 shows valid TCI state configurations if the target antenna port is CSI-RS for BM (the same meaning as CSI-RS for L1 RSRP reporting). The CSI-RS for BM may indicate NZP CSI-RS in which the repetition parameter is configured to have a value of On or Off and trs-Info is not set to true in the CSI-RS. The disclosure is not limited thereto.

TABLE 15-3
Valid TCI state configurations if the target antenna
port is CRS-RS for BM (for L1 RSRP reporting)

| Valid TCI | | | | qcl-Type2 |
|---|---|---|---|---|
| state | | | DL RS 2 | (if |
| Configuration | DL RS 1 | qcl-Type1 | (if configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH | QCL-TypeD |
| | Block | | Block | |

Table 15-4 shows valid TCI state configurations if the target antenna port is a PDCCH DMRS. The disclosure is not limited thereto.

TABLE 15-4
Valid TCI state configurations if the
target antenna port is PDCCH DMRS

| Valid TCI | | | | |
|---|---|---|---|---|
| state | DL | | DL RS 2 | qcl-Type2 |
| Configuration | RS 1 | qcl-Type1 | (if configured) | (if configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS | QCL-TypeA | CSI-RS (same | QCL-TypeD |
| | (CSI) | | as DL RS 1) | |

Table 15-5 shows valid TCI state configurations if the target antenna port is a PDSCH DMRS. The disclosure is not limited thereto.

TABLE 15-5
Valid TCI state configurations if the
target antenna port is PDSCH DMRS

| Valid TCI | | | | |
|---|---|---|---|---|
| state | DL | | DL RS 2 | qcl-Type2 |
| Configuration | RS 1 | qcl-Type1 | (if configured) | (if configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | CSI-RS (CSI) | QCL-TypeD |
| | (CSI) | | | |

A representative QCL configuration method based on the above Tables 15-1 through 15-5 configures and operates the target antenna port and the reference antenna port per step as “SSB”->“TRS”->“CSI-RS for CSI, CSI-RS for BM, PDCCH DMRS, or PDSCH DMRS.” Thus, statistical characteristics measurable from the SSB and the TRS may be associated with the respective antenna ports, thus assisting the reception operation of the UE.

[Pdcch: Tci States]

Specifically, TCI state combinations applicable to the PDCCH DMRS antenna port are shown in the following Table 16. A fourth row in Table 16 is a combination assumed by the UE before RRC configuration and may not be configured after the RRC.

TABLE 16

| Valid TCI | | | DL RS 2 | |
|---|---|---|---|---|
| state | | | (if | qcl-Type2 |
| Configuration | DL RS 1 | qcl-Typel | configured) | (if configured) |
| 1 | TRS | QCL- | TRS | QCL-TypeD |
| | | TypeA | | |
| 2 | TRS | QCL- | CSI-RS (BM) | QCL-TypeD |
| | | TypeA | | |
| 3 | CSI-RS | QCL- | | |
| | (CSI) | TypeA | | |
| 4 | SS/PBCH | QCL- | SS/PBCH | QCL-TypeD |
| | Block | TypeA | Block | |

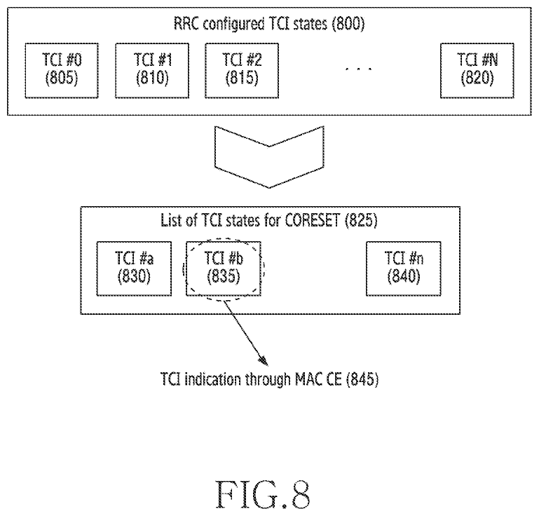

FIG. 8 illustrates an example of a TCI state allocation method for a PDCCH in a wireless communication system according to an embodiment of the present disclosure.

The NR may support a hierarchical signaling method as shown in FIG. 8 for PDCCH beam dynamic allocation. Referring to FIG. 8, the eNode B may configure N TCI states 805, 810, 815, . . . , 820 for the UE through RRC signaling 800, and configure some of them as TCI states for CORESET 825. Next, the eNode B may indicate one of the TCI states 830, 835, and 840 for CORESET to the UE through MAC CE signaling 845. Next, the UE receives the PDCCH, based on beam information included in the TCI state indicated by the MAC CE signaling.

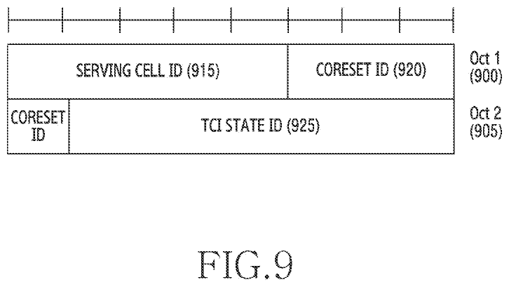

FIG. 9 illustrates a TCI indication MAC CE signaling structure for a PDCCH DMRS in a wireless communication system according to an embodiment of the present disclosure. Referring to FIG. 9, the TCI indication MAC CE signaling for the PDCCH DMRS may include 2 bytes (16 bits) and include a 5-bit serving cell ID 915, a 4-bit CORESET ID 920, and a 7-bit TCI state ID 925.

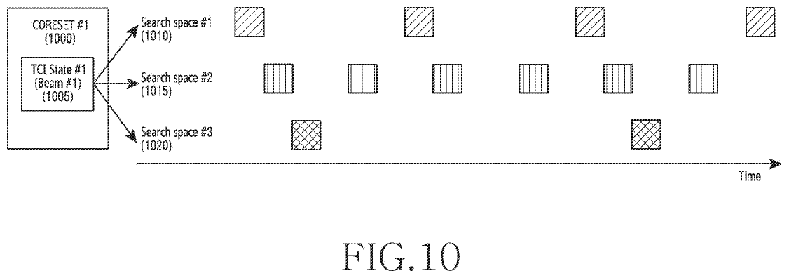

FIG. 10 illustrates a beam configuration example of a CORESET and a search space in a wireless communication system according to an embodiment of the present disclosure.

Referring to FIG. 10, the eNode B may indicate one 1005 in a TCI state list included in the configuration of a CORESET 1000 through MAC CE signaling. Next, until another TCI state is indicated to a corresponding CORESET through another MAC CE signaling, the UE may consider that the same QCL information (beam #1) is applied to one or more search spaces 1010, 1015, and 1020 linked to the CORESET. The above-described PDCCH beam allocation method has a difficulty in indicating faster beam change than the MAC CE signaling delay, and performing flexible PDCCH beam management because the PDCCH beam allocation method collectively applies the same beam to all CORESETs regardless of search space characteristics. Hereafter, embodiments of the disclosure provide a more flexible PDCCH beam configuration and management method. Hereafter, several distinct examples will be provided to describe embodiments of the disclosure to ease the description but are not mutually exclusive and may be applied by appropriately combining with each other according to circumstances.

The eNode B may configure one or more TCI states for the UE with respect to a specific CORESET, and activate one of the configured TCI states through a MAC CE activation command. For example, {TCI state #0, TCI state #1, TCI state #2} is configured as the TCI states in a CORESET #1, and the base station may transmit to the UE a command for activation to assume TCI state #0 as the TCI state of the CORESET #1 through a MAC CE. Based on the TCI state activation command received through the MAC CE, the UE may correctly receive a DMRS of the corresponding CORESET based on QCL information of the activated TCI state.

With respect to the CORESET having the index 0 (CORESET #0), if the UE does not receive the MAC CE activation command for the TCI state of the CORESET #0, the UE may assume that the DMRS transmitted in the CORESET #0 is QCLed with an SS/PBCH block identified in the initial access procedure or in the non-contention based random access procedure not triggered by a PDCCH command.

With respect to the CORESET having other index than 0 (CORESET #X), if the UE is not configured with TCI state configuration for CORESET #X, or is configured with one or more TCI states but receives no MAC CE activation command for activating one of them, the UE may assume that the DMRS transmitted in the CORESET #X is QCLed with the SS/PBCH block identified in the initial access process.

[PDCCH: QCL Prioritization Rule]

Hereafter, QCL prioritization for the PDCCH is described in detail.

If the UE operates as carrier aggregation (CA) in a single cell or band, and a plurality of CORESETs existing in an activated BWP of a single or multiple cells has the same or different QCL-TypeD characteristics in a specific PDCCH monitoring period and overlaps in time, the UE may select a specific CORESET according to the QCL prioritization, and monitor CORESETs having the same QCL-TypeD characteristic as the corresponding CORESET. That is, if a plurality of CORESETs overlaps in time, only one QCL-TypeD characteristic may be received. In this case, criteria for the QCL prioritization may be as follows:
Criterion 1: A CORESET linked to a common search space of the lowest index, in a cell corresponding to the lowest index among the cells including common search spaces; and
Criterion 2: A CORESET linked to a UE-specific search space of the lowest index, in a cell corresponding to the lowest index among the cells including UE-specific search spaces.

As above, if the corresponding criterion is not satisfied, the above criteria each applies the next criterion. For example, if CORESETs overlap on time in a specific PDCCH monitoring period, and all the CORESETs are linked to the UE-specific search space instead of the common search space, that is, the criterion 1 is not satisfied, the UE may omit applying the criterion 1 and apply the criterion 2.

If selecting CORESETs based on the above-mentioned criteria, the UE may further consider the following two items with respect to QCL information configured in the CORESET. First, if a CORESET 1 has a CSI-RS 1 as the reference signal having the QCL-TypeD relationship, the reference signal with which the CSI-RS 1 has the QCL-TypeD relationship is SSB 1, and a reference signal with which a CORESET 2 has the QCL-TypeD relationship is SSB 1, the UE may consider that the two CORESETs 1 and 2 have different QCL-TypeD characteristics. Second, if the CORESET 1 has CSI-RS 1 configured in a cell 1 as the reference signal having the QCL-TypeD relationship, the reference signal with which CSI-RS 1 has the QCL-TypeD relationship is SSB 1, the CORESET 2 has CSI-RS 2 configured in a cell 2 as the reference signal having the QCL-TypeD relationship, and the reference signal with which the CSI-RS 2 has the QCL-TypeD relationship is SSB 1, the UE may consider that the two CORESETs have the same QCL-TypeD characteristic.

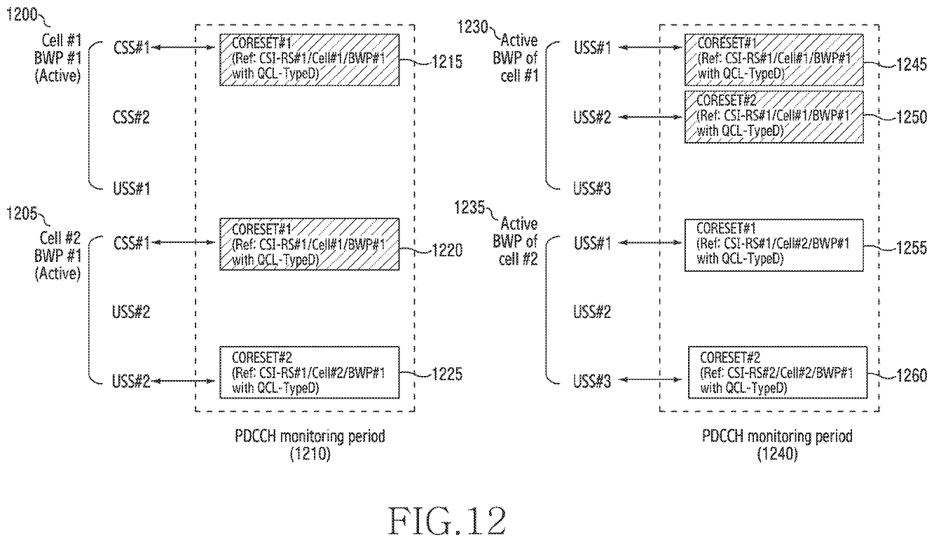

FIG. 12 illustrates a method of a terminal for selecting a receivable CORESET by considering priority if receiving a downlink control channel in a wireless communication system according to an embodiment of the present disclosure. For example, the UE may be configured to receive a plurality of CORESETs overlapping on time in a specific PDCCH monitoring period 1210, and the plurality of the CORESETs may be linked to common search spaces or UE-specific search spaces in a plurality of cells. In the corresponding PDCCH monitoring period 1210, a first CORESET 1215 linked to a first common search space may exist in a first BWP 1200 of a first cell, and a first CORESET 1220 linked to the first common search space and a second CORESET 1225 linked to a second UE-specific search space may exist in a first BWP 1205 of a second cell. The CORESET 1215 and the CORESET 1220 may have the QCL-TypeD relationship with a first CSI-RS resource configured in the first BWP of the first cell, and the CORESET 1225 may have the QCL-TypeD relationship with a first CSI-RS resource configured in the first BPW of the second cell. Hence, if the criterion 1 is applied to the corresponding PDCCH monitoring period 1210, every other CORESET having the same QCL-TypeD reference signal as the first CORESET 1215 may be received. Thus, the UE may receive the CORESET 1215 and the CORESET 1220 in the corresponding PDCCH monitoring period 1210.

As another example, the UE may be configured to receive a plurality of CORESETs overlapping on time in a specific PDCCH monitoring period 1240, and the plurality of the CORESETs may be linked to common search spaces or UE-specific search spaces in a plurality of cells. In the corresponding PDCCH monitoring period 1240, a first CORESET 1245 linked to a first UE-specific search space and a second CORESET 1250 linked to a second UE-specific search space may exist in a first BPW 1230 of a first cell, and a first CORESET 1255 linked to the first UE-specific search space and a second CORESET 1260 linked to a third UE-specific search space may exist in a first BWP 1235 of a second cell. The CORESET 1245 and the CORESET 1250 may have the QCL-TypeD relationship with a first CSI-RS resource configured in the first BWP of the first cell, the CORESET 1255 may have the QCL-TypeD relationship with a first CSI-RS resource configured in the first BWP of the second cell, and the CORESET 1260 may have the QCL-TypeD relationship with a second CSI-RS resource configured in the first BWP of the second cell. However, if the criterion 1 is applied to the corresponding PDCCH monitoring period 1240, there is no common search space and accordingly the next criterion 2 may be applied. If the criterion 2 is applied to the corresponding PDCCH monitoring period 1240, every other CORESET having the same QCL-TypeD reference signal as the CORESET 1245 may be received. Hence, the UE may receive the CORESET 1245 and the CORESET 1250 in the corresponding PDCCH monitoring period 1240.

[Rate Matching/Puncturing]

Hereafter, rate matching and puncturing is described in detail.

If time and frequency resources A to transmit an arbitrary symbol sequence A overlap arbitrary time and frequency resources B, the rate matching or the puncturing may be considered as transmission and reception of a channel A in consideration of a resource C of an area where the resources A and the resources B overlap. Detailed operations thereof may be as follows.

Rate Matching

The eNode B may map and transmit the channel A only to other resource areas than the resource C corresponding to the overlapping area of the resources B among all the resources A for transmitting the symbol sequence A to the UE. For example, if the symbol sequence A includes {symbol #1, symbol #2, symbol #3, symbol #4}, the resources A are {resource1, resource #2, resource #3, resource #4}, and the resources B are {resource #3, resource #5}, the eNode B may transmit the symbol sequence A by sequentially mapping the symbol sequence A to other resources {resource #1, resource #2, resource #4} than {resource #3} corresponding to the resource C among the resources A. As a result, the eNode B may map and transmit the symbol sequence {symbol #1, symbol #2, symbol #3} to {resource #1, resource #2, resource #4} respectively.

The UE may determine the resources A and the resources B from scheduling information of the symbol sequence A from the eNode B, and thus determine the resource C which is the overlapping area of the resources A and the resources B. The UE may receive the symbol sequence A by assuming that the symbol sequence A is mapped and transmitted in the other area than the resource C among all the resources A. For example, if the symbol sequence A includes {symbol #1, symbol #2, symbol #3, symbol #4}, the resources A are {resource #1, resource #2, resource #3, resource #4}, and the resources B are {resource #3, resource #5}, the UE may receive the symbol sequence A by assuming that the symbol sequence A is sequentially mapped to other resources {resource #1, resource #2, resource #4} than {resource #3} corresponding to the resource C among the resources A. As a result, the UE may assume that the symbol sequence {symbol #1, symbol #2, symbol #3} being mapped to the resources {resource #1, resource #2, resource #4} is transmitted and perform a series of subsequent reception operations.

Puncturing Operation

If all the resources A for transmitting the symbol sequence A to the UE include the resource C corresponding to the overlapping area of the resources B, the eNode B may map the symbol sequence A to all the resources A but may transmit only in other resource areas than the resource C among the resources A, without transmitting in the resource area corresponding to the resource C. For example, if the symbol sequence A includes {symbol #1, symbol #2, symbol #3, symbol #4}, the resources A are {resource #1, resource #2, resource #3, resource #4}, and the resources B are {resource #3, resource #5}, the eNode B may map the symbol sequence A {symbol #1, symbol #2, symbol #3, symbol #4} to the resources A {resource #1, resource #2, resource #3, resource #4} respectively, may transmit only a symbol sequence {symbol #1, symbol #2, symbol #4} corresponding to {resource #1, resource #2, resource #4} which are other resources than {resource #3} corresponding to the resource C among the resources A, and may not transmit {symbol #3} mapped to {resource #3} corresponding to the resource C. As a result, the eNode B may transmit the symbol sequence {symbol #1, symbol #2, symbol #4} mapped to {resource #1, resource #2, resource #4} respectively.

The UE may determine the resources A and the resources B from scheduling information of the symbol sequence A from the eNode B, and accordingly determine the resource C which is the overlapping area of the resources A and the resources B. The UE may receive the symbol sequence A by assuming that the symbol sequence A is mapped to the whole resources A but transmitted only in the other area than the resource C among the resource areas A. For example, if the symbol sequence A includes {symbol #1, symbol #2, symbol #3, symbol #4}, the resources A are {resource #1, resource #2, resource #3, resource #4}, and the resources B are {resource #3, resource #5}, the UE may receive the symbol sequence A by assuming that the symbol sequence A {symbol #1, symbol #2, symbol #3, symbol #4} is mapped to the resources A {resource #1, resource #2, resource #3, resource #4} respectively, but {symbol #3} mapped to {resource #3} corresponding to the resource C is not transmitted, and assuming that the symbol sequence {symbol #1, symbol #2, symbol #4} corresponding to the other resources {resource #1, resource #2, resource #4} than {resource #3} corresponding to the resource C among the resources A is mapped and transmitted. As a result, the UE may perform a series of subsequent reception operations by assuming that the symbol sequence {symbol #1, symbol #2, symbol #4} is mapped to the resources {resource #1, resource #2, resource #4} respectively and transmitted.

Hereafter, a method of configuring a rate matching resource for the sake of the rate matching in the 5G communication system will be described. The rate matching indicates adjusting a signal magnitude in consideration of a resource amount for transmitting the signal. For example, rate matching of a data channel may indicate adjusting a data size by not mapping and transmitting the data channel for specific time and frequency resource areas.

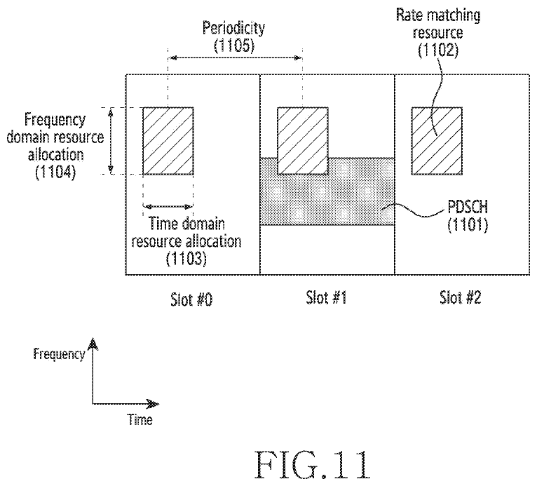

FIG. 11 illustrates a method of a base station and a terminal for transmitting and receiving data by considering a downlink control channel and a rate matching resource in a wireless communication system according to an embodiment of the present disclosure.

FIG. 11 shows a downlink data channel (PDSCH) 1101 and a rate matching resource 1102. The eNode B may configure one or more rate matching resources 1102 for the UE through higher layer signaling (e.g., RRC signaling). Configuration information of the rate matching resource 1102 may include time domain resource allocation information 1103, frequency domain resource allocation information 1104, and periodicity information 1105. Hereafter, it is assumed that a bitmap corresponding to the frequency domain resource allocation information 1104 is referred to as a “first bitmap,” a bitmap corresponding to the time domain resource allocation information 1103 is referred to as a “second bitmap,” and a bitmap corresponding to the periodicity information 1105 is referred to as a “third bitmap.” If all or some of the time and frequency resources of the scheduled data channel 1101 overlap the configured rate matching resources 1102, the eNode B may rate-match and transmit the data channel 1101 in the rate matching resource 1102, and the UE may perform reception and decoding after assuming that the data channel 1101 is rate-matched in the rate matching resource 1102.

The eNode B may dynamically notify the UE through DCI of whether to rate-match the data channel in the configured rate matching resource through additional configuration (corresponding to the “rate matching indicator” in the DCI format described above). Specifically, the eNode B may select some of the configured rate matching resources to group them into a rate matching resource group, and indicate whether to rate-match the data channel for each rate matching resource group to the UE through the DCI using a bitmap. For example, if four rate matching resources RMR #1, RMR #2, RMR #3, and RMR #4 are configured, the eNode B may configure RMG #1={RMR #1, RMR #2} and RMG #2={RMR #3, RMR #4} as rate matching groups, and indicate to the UE whether to rate-match in RMG #1 and RMG #2 respectively with a bitmap using 2 bits of a DCI field. For example, “1” may be indicated to perform the rate-matching, and “0” may be indicated not to perform the rate-matching.

The 5G supports granularity of an “RB symbol level” and an “RE level” as the method for configuring the above-described rate matching resource for the UE. More specifically, the following configuration method may be provided.

RB Symbol Level

The UE may be configured with up to four RateMatchPatterns per BWP through higher layer signaling, and one RateMatchPattern may include the following. However, the disclosure is not limited thereto:
As a reserved resource in the BWP, a resource in which time and frequency resource areas of the corresponding reserved resource are configured with a combination of an RB level bitmap and a symbol level bitmap in the frequency axis may be included. The reserved resource may be spanned over one or two slots. A time domain pattern periodicityAndPattern in which time and frequency domains including a pair of RB level and symbol level bitmaps are repeated may be further configured; and
Time and frequency domain resource areas configured as a CORESET in the BWP and a resource area corresponding to a time domain pattern configured as the search space in which the corresponding resource region is repeated may be included.

RE Level

The UE may be configured as below through higher layer signaling. However, the disclosure is not limited thereto:
RE configuration information lte-CRS-ToMatchAround corresponding to an LTE cell-specific reference signal or common reference signal (CRS) pattern may include the number of LTE CRS ports nrofCRS-Ports and an LTE-CRS-vshift(s) value v-shift, center subcarrier location information carrierFreqDL of an LTE carrier from a reference frequency point (e.g., a reference point A), LTE carrier bandwidth size information carrierBandwidthDL, subframe configuration information mbsfn-SubframConfigList corresponding to a multicast-broadcast single-frequency network (MBSFN), and so on. The UE may determine a CRS location in an NR slot corresponding to an LTE subframe, based on the above-described information; and
Configuration information of a resource set corresponding to one or more zero power (ZP) CSI-RS in the BWP may be included.

[LTE CRS Rate Match]

Next, the rate matching of the above-described LTE CRS will be described in detail. For LTE-NR coexistence, the NR provides an NR UE with a function of configuring a CRS pattern of the LTE. Specifically, the CRS pattern may be provided by RRC signaling including at least one parameter in ServingCellConfig information element (IE) or ServingCellConfigCommon IE. For example, the parameter may include lte-CRS-ToMatchAround, lte-CRS-PatternList1-r16, lte-CRS-PatternList2-r16, crs-RateMatch-PerCORESETPoolIndex-r16, and the like.

Rel-15 NR provides a function for configuring one CRS pattern per serving cell through the parameter lte-CRS-ToMatchAround. In Rel-16 NR, the function has been extended to enable configuring a plurality of CRS patterns per serving cell. Specifically, one CRS pattern for one LTE carrier may be configured in a single-transmission and reception point (TRP) configured UE, and two CRS patterns for one LTE carrier may be configured in a multi-TRP configured UE. For example, up to three CRS patterns per serving cell may be configured in the single-TRP configured UE through the parameter lte-CRS-PatternList1-r16. As another example, the CRS may be configured per TRP in the multi-TRP configured UE.

That is, a CRS pattern for a TRP1 may be configured through the parameter lte-CRS-PatternList1-r16, and a CRS pattern for a TRP2 may be configured through a parameter lte-CRS-PatternList2-r16. Meanwhile, if two TRPs are configured as above, whether to apply both the CRS patterns of TRP1 and TRP2 to a specific PDSCH, or whether to apply only the CRS pattern for one TRP may be determined through a parameter crs-RateMatch-PerCORESETPoolIndex-r16. If the parameter crs-RateMatch-PerCORESETPoolIndex-r16 is configured to be enabled, only the CRS pattern of one TRP may be applied, and otherwise, the CRS patterns of the two TRPs may be applied.

Table 17 shows the ServingCellConfig IE including the CRS pattern, and Table 18 shows a RateMatchPatternLTE-CRS IE including at least one parameter for the CRS pattern.

TABLE 17

| | |
|---|---|
| ServingCellConfig ::= | SEQUENCE { |

| | |
|---|---|
| tdd-UL-DL-ConfigurationDedicated | TDD-UL-DL-ConfigDedicated |
| OPTIONAL, -- Cond TDD | |
| initialDownlinkBWP | BWP-DownlinkDedicated |
| OPTIONAL, -- Need M | |

| | |
|---|---|
| downlinkBWP-ToReleaseList | SEQUENCE (SIZE (1..maxNrofBWPs)) OF BWP- |

| | |
|---|---|
| Id | OPTIONAL, -- Need N |

| | |
|---|---|
| downlinkBWP-ToAddModList | SEQUENCE (SIZE (1..maxNrofBWPs)) OF |

| | |
|---|---|
| BWP-Downlink | OPTIONAL, -- Need N |

| | |
|---|---|
| firstActiveDownlinkBWP-Id | BWP-Id |
| OPTIONAL, -- Cond SyncAndCellAdd | |

| | |
|---|---|
| bwp-Inactivity Timer | ENUMERATED {ms2, ms3, ms4, ms5, ms6, ms8, ms10, |

ms20, ms30,

ms40,ms50, ms60, ms80,ms100, ms200,ms300, ms500,
ms750, ms1280, ms1920, ms2560, spare10, spare9, spare8,
spare7, spare6, spare5, spare4, spare3, spare2, spare1 }

| | |
|---|---|
| OPTIONAL, -- Need R | |
| defaultDownlinkBWP-Id | BWP-Id |
| OPTIONAL, -- Need S | |
| uplinkConfig | UplinkConfig |
| OPTIONAL, -- Need M | |
| supplementaryUplink | UplinkConfig |
| OPTIONAL, -- Need M | |

| | |
|---|---|
| pdcch-ServingCellConfig | SetupRelease { PDCCH-ServingCellConfig } |

OPTIONAL, -- Need M

| | |
|---|---|
| pdsch-ServingCellConfig | SetupRelease { PDSCH-ServingCellConfig } |

OPTIONAL, -- Need M

| | |
|---|---|
| csi-MeasConfig | SetupRelease { CSI-MeasConfig } |

OPTIONAL, -- Need M

| | |
|---|---|
| sCellDeactivation Timer | ENUMERATED {ms20, ms40, ms80, ms160, ms200, |

ms240,

ms320, ms400, ms480, ms520, ms640, ms720,
ms840, ms1280, spare2,spare1 } OPTIONAL, --

| | |
|---|---|
| Cond ServingCellWithoutPUCCH | |
| crossCarrierSchedulingConfig | CrossCarrierSchedulingConfig |
| OPTIONAL, -- Need M | |

| | |
|---|---|
| tag-Id | TAG-Id, |

| | |
|---|---|
| dummy | ENUMERATED {enabled} |
| OPTIONAL, -- Need R | |
| pathlossReferenceLinking | ENUMERATED {spCell, sCell} |
| OPTIONAL, -- Cond SCellOnly | |
| servingCellMO | MeasObjectId |
| OPTIONAL, --Cond MeasObject | |
| ..., | |
| [[ | |

| | |
|---|---|
| lte-CRS-ToMatchAround | SetupRelease { RateMatchPatternLTE-CRS } |

| | |
|---|---|
| OPTIONAL, -- Need M | |
| rateMatchPatternToAddModList | SEQUENCE (SIZE |
| (1..maxNrofRateMatchPatterns)) OF RateMatchPattern | OPTIONAL, -- Need N |
| rateMatchPatternToReleaseList | SEQUENCE (SIZE |
| (1..maxNrofRateMatchPatterns)) OF RateMatchPatternId | OPTIONAL, -- Need N |

| | |
|---|---|
| downlinkChannelBW-PerSCS-List | SEQUENCE (SIZE (1..maxSCSs)) OF SCS- |

| | |
|---|---|
| SpecificCarrier | OPTIONAL -- Need S |

| | |
|---|---|
| ]], | |
| [[ | |
| supplementaryUplinkRelease | ENUMERATED { true} |
| OPTIONAL, -- Need N | |
| tdd-UL-DL-ConfigurationDedicated-IAB-MT-r16 | TDD-UL-DL-ConfigDedicated- |

| | |
|---|---|
| IAB-MT-r16 | OPTIONAL, -- Cond TDD_IAB |

| | |
|---|---|
| dormantBWP-Config-r16 | SetupRelease { DormantBWP-Config-r16 } |

OPTIONAL, -- Need M

| | |
|---|---|
| ca-SlotOffset-r16 | CHOICE { |

| | |
|---|---|
| refSCS15kHz | INTEGER (−2..2), |
| refSCS30KHz | INTEGER (−5..5), |
| refSCS60KHz | INTEGER (−10..10), |
| refSCS120KHz | INTEGER (−20..20) |

| | |
|---|---|
| } | OPTIONAL, -- |
| Cond AsyncCA | |

| | |
|---|---|
| channelAccessConfig-r16 | SetupRelease { ChannelAccessConfig-r16 } |

OPTIONAL, -- Need M

| | |
|---|---|
| intraCellGuardBandsDL-List-r16 | SEQUENCE (SIZE (1..maxSCSs)) OF |

| | |
|---|---|
| IntraCellGuardBandsPerSCS-r16 | OPTIONAL, -- Need S |

| | |
|---|---|
| intraCellGuardBandsUL-List-r16 | SEQUENCE (SIZE (1..maxSCSs)) OF |

| | |
|---|---|
| IntraCellGuardBandsPerSCS-r16 | OPTIONAL, -- Need S |

| | |
|---|---|
| csi-RS-ValidationWith-DCI-r16 | ENUMERATED {enabled} |
| OPTIONAL, -- Need R | |

| | |
|---|---|
| lte-CRS-PatternList1-r16 | SetupRelease { LTE-CRS-PatternList-r16 } |
| OPTIONAL, -- Need M | |
| lte-CRS-PatternList2-r16 | SetupRelease { LTE-CRS-PatternList-r16 } |

| | |
|---|---|
| OPTIONAL, -- Need M | |
| crs-RateMatch-PerCORESETPoolIndex-r16 | ENUMERATED {enabled} |
| OPTIONAL, -- Need R | |
| enableTwoDefaultTCI-States-r16 | ENUMERATED {enabled} |
| OPTIONAL, -- Need R | |
| enableDefaultTCI-StatePerCoresetPoolIndex-r16 | ENUMERATED {enabled} |
| OPTIONAL, -- Need R | |
| enableBeamSwitchTiming-r16 | ENUMERATED {true} |
| OPTIONAL, -- Need R | |
| cbg-TxDiffTBsProcessingType1-r16 | ENUMERATED {enabled} |
| OPTIONAL, -- Need R | |
| cbg-TxDiffTBsProcessingType2-r16 | ENUMERATED {enabled} |
| OPTIONAL -- Need R | |
| ]] | |
| } | |

TABLE 18
-- RateMatchPatternLTE-CRS

The IE RateMatchPatternLTE-CRS is used to configure a pattern to rate match around LTE
CRS. See TS 38.214 [19], clause 5.1.4.2.
RateMatchPatternLTE-CRS information element
-- ASN1START
-- TAG-RATEMATCHPATTERNLTE-CRS-START

| | |
|---|---|
| RateMatchPatternLTE-CRS ::= | SEQUENCE { |

| | |
|---|---|
| carrierFreqDL | INTEGER (0..16383), |

| | |
|---|---|
| carrierBandwidthDL | ENUMERATED {n6, n15, n25, n50, n75, n100, spare2, |

spare1},

| | |
|---|---|
| mbsfn-SubframeConfigList | EUTRA-MBSFN-SubframeConfigList |

OPTIONAL, -- Need M

| | |
|---|---|
| nrofCRS-Ports | ENUMERATED {n1, n2, n4}, |

| | |
|---|---|
| v-Shift | ENUMERATED {n0, n1, n2, n3, n4,05} |

}

| | |
|---|---|
| LTE-CRS-PatternList-r16 ::= | SEQUENCE (SIZE (1.maxLTE-CRS-Patterns-r16) OF |

RateMatchPatternLTE-CRS
-- TAG-RATEMATCHPATTERNLTE-CRS-STOP
-- ASN1STOP
RateMatchPatternLTE-CRS field descriptions
carrierBandwidthDL
BW of the LTE carrier in number of PRBs (see TS 38.214, clause 5.1.4.2).
carrierFreqDL
Center of the LTE carrier (see TS 38,214, clause 5.1.4.2).
mbsfn-SubframeConfigList
LTE MBSFN subframe configuration (see TS 38.214, clause 5.1.4.2).
nrofCRS-Ports
Number of LTE CRS antenna port to rate-match around (see TS 38.214, clause 5.1.4.2).
v-Shift
Shifting value v-shift in LTE to rate match around LTE CRS (see TS 38.214, clause 5.1.4.2).

[UE Capability Report]

In the LTE and the NR, the UE may perform a procedure of reporting capability supported by the UE to a corresponding eNode B while being connected to the serving eNode B. This is referred to as UE capability report in the following description.

The eNode B may transmit a UE capability enquiry message requesting the capability report to the UE of the connected state. The UE capability enquiry message may include a UE capability request per radio access technology (RAT) type of the base station. The request per RAT type may include supported frequency band combination information. In addition, the UE capability enquiry message may request UE capability for a plurality of RAT types through a single RRC message container transmitted by the eNode B, or the eNode B may transmit to the UE a message including a plurality of UE capability enquiries including the UE capability request per RAT type. That is, the UE capability enquiry may be repeated multiple times in a single message, and the UE may configure a UE capability information message corresponding thereto and report the same multiple times. The next-generation mobile communication system may request the UE capability with respect to multi-RAT dual connectivity (MR-DC) as well as the NR, the LTE, and E-UTRA-NR dual connectivity (EN-DC). In addition, the UE capability enquiry message may be generally transmitted in the initial stage after the UE is connected to the eNode B, but the eNode B may request the UE capability under any condition if necessary.

According to an embodiment, the UE receiving the UE capability report request from the eNode B may configure UE capability according to the RAT type and the band information requested from the eNode B. A method for configuring the UE capability at the UE in the NR system is as follows.

1. If the UE receives an LTE and/or NR band list from the eNode B at the UE capability request, the UE configures a band combination (BC) for the EN-DC and NR standalone (SA). That is, the UE may configure a BC candidate list for the EN-DC and the NR SA, based on the bands requested by the eNode B using FreqBandList. In addition, the bands may have priority in order as described in FreqBandList.

2. If the eNode B requests the UE capability report by configuring a “eutra-nr-only” flag or a “eutra” flag, the UE may completely remove the NR SA BCs from the configured BC candidate list. This operation may be performed only if the LTE eNB requests “eutra” capability.

3. Next, the UE removes fallback BCs from the BC candidate list configured in the above step. Herein, the fallback BC indicates a BC obtainable by removing a band corresponding to at least one SCell from a specific BC, and may be omitted because the BC before removing the band corresponding to at least one SCell may cover the fallback BC. This step is also applied to the MR-DC, that is, to the LTE bands. After this step, the remaining BCs may make a final “candidate BC list.”

4. The UE selects BCs to report by selecting the BCs conforming to the requested RAT type from the final “candidate BC list.” In this step, the UE may configure supportedBandCombinationList in a designated order. In other words, the UE may configure the BC and the UE capability to report according to a preset rat-Type order (nr-eutra-nr-eutra). In addition, the UE may configure featureSetCombination for the configured supportedBandCombinationList, and configure a list of “candidate feature set combinations” from the candidate BC list from which the fallback BC list (including capabilities of the equal or lower level) is removed. “candidate feature set combination” may include every feature set combination of NR and EUTRA-NR BC, and may be obtained from the feature set combination of UE-NR-Capabilities and UE-MRDC-Capabilities containers.

5. In addition, if the requested rat Type is “eutra-nr” and exerts influence, featureSetCombinations may be included in two containers of UE-MRDC-Capabilities and UE-NR-Capabilities. However, the feature set of the NR many be included only in UE-NR-Capabilities.

After the UE capability is configured, the UE may transmit a UE capability information message including the UE capability to the eNode B. The eNode B may perform appropriate scheduling and transmission and reception management for the corresponding UE, based on the UE capability received from the UE.

[CA/DC]

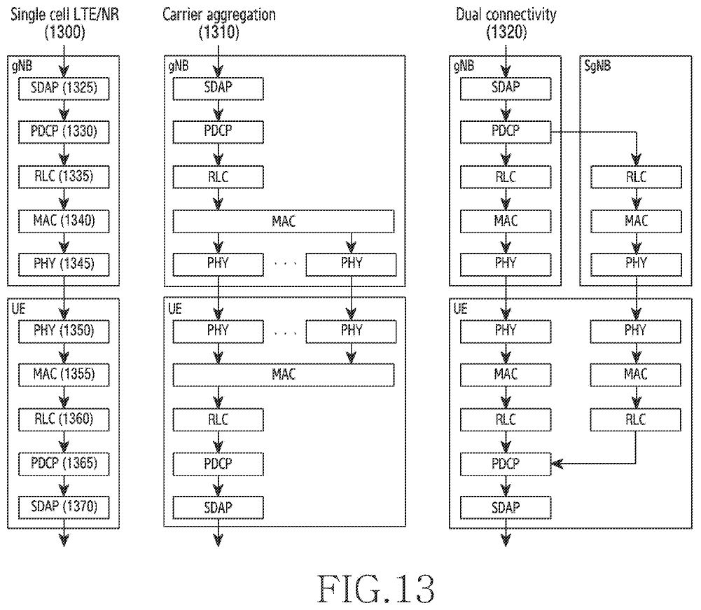

FIG. 13 illustrates a radio protocol structure of a base station and a terminal in a single cell, carrier aggregation, and dual connectivity in a wireless communication system according to an embodiment of the present disclosure.

Referring to FIG. 13, the radio protocol of the next-generation mobile communication system may include NR service data adaption protocol (SDAP) 1325 and 1370, NR packet data convergence protocol (PDCP) 1330 and 1365, NR radio link control (RLC) 1335 and 1360, and NR MAC 1340 and 1355 in the UE and the NR eNode B respectively.

Primary functions of the NR SDAP 1325 or 1370 may include some of the following functions:
Transfer of user plane data;
Mapping between QoS flow and DRB for both DL and UL;
Marking QoS flow ID in both DL and UL packets; and
Mapping reflective QoS flow to DRB for UL SDAP PDUs.

For the SDAP layer device, the UE may be configured with whether to use a header of the SDAP layer device or whether to use functions of the SDAP layer device for each PDCP layer device, for each bearer, or for each logical channel through an RRC message. If the SDAP header is configured, a 1-bit NAS reflective QoS configuration indicator and a 1-bit AS reflective QoS configuration indicator of the SDAP header may instruct the UE to update or reconfigure mapping information of QoS flows and data bearers of the uplink and the downlink. The SDAP header may include QoS flow ID information indicating QoS. The QoS information may be used as data processing priority, scheduling information, or the like to support a seamless service.

Primary functions of the NR PDCP 1330 or 1365 may include some of the following functions:
Header compression and decompression (ROHC only);
Transfer of user data;
In-sequence delivery of upper layer PDUs;
Out-of-sequence delivery of upper layer PDUs;
PDCP PDU reordering for reception;
Duplicate detection of lower layer SDUs;
Retransmission of PDCP SDUs;
Ciphering and deciphering; and
Timer-based SDU discard in uplink.

The reordering of the NR PDCP layer device indicates a function of reordering PDCP PDUs received from a lower layer, based on a PDCP sequence number (SN), and may include a function of transmitting data to a higher layer in the reordered order. Alternatively, the reordering of the NR PDCP layer device may include a function of directly transmitting data without considering the order, a function of reordering the sequence and recording lost PDCP PDUs, a function of transmitting a status report of the lost PDCP PDUs to a transmitting side, and a function of requesting to retransmit the lost PDCP PDUs.

Primary functions of the NR RLC 1335 or 1360 may include some of the following functions:
Transfer of upper layer PDUs;
In-sequence delivery of upper layer PDUs;
Out-of-sequence delivery of upper layer PDUs;
Error correction through ARQ;
Concatenation, segmentation, and reassembly of RLC SDUs;
Re-segmentation of RLC data PDUs;
Reordering of RLC data PDUs;
Duplicate detection;
Protocol error detection;
RLC SDU discard; and
RLC re-establishment.

The in-sequence delivery of the NR RLC layer device indicates a function of transferring RLC SDUs received from a lower layer to a higher layer in sequence. The in-sequence delivery of the NR RLC layer device may include at least one of, if one original RLC SDU is divided into a plurality of RLC SDUs and received, reassembling and transmitting them, reordering the received RLC PDUs based on an RLC SN or a PDCP SN, reordering and recording lost RLC PDUs, transmitting a status report of the lost RLC PDUs to the transmitting side, and requesting to retransmit the lost RLC PDUs. The in-sequence delivery the NR RLC layer device may include at least one of, if there is a lost RLC SDU, transmitting only the RLC SDUs prior to the lost RLC SDU to a higher layer in sequence, and, if there is a lost RLC SDU but a designated timer expires, transmitting all RLC SDUs received before the timer starts to the higher layer in sequence. Alternatively, the in-sequence delivery of the NR RLC layer device may include, if there is a lost RLC SDU but a designated timer expires, transmitting all RLC SDUs received so far to a higher layer in sequence.

In addition, the in-sequence delivery of the NR RLC layer device may process the RLC PDUs in their reception order (in order of arrival, regardless of the serial number or the SN) and transmit them to the PDCP layer device out-of-sequence delivery, and may receive segments stored in a buffer or to be received and reconstruct them into one complete RLC PDU, and then process and transmit the RLC PDU to the PDCP layer device.

The NR RLC layer may not include a concatenation function, and the concatenation function may be performed in the NR MAC layer or replaced by a multiplexing function of the NR MAC layer.

The out-of-sequence delivery of the NR RLC layer device indicates a function of directly transmitting RLC SDUs received from a lower layer to a higher layer regardless of the sequence, and may include, if one original RLC SDU is divided into a plurality of RLC SDUs and received, reassembling and transmitting them, and storing and ordering RLC SNs or PDCP SNs of the received RLC PDUs and recording lost RLC PDUs.

The NR MAC 1340 or 1355 may be connected to several NR RLC layer devices configured in a single UE, and primary functions of the NR MAC may include some of the following functions:
Mapping between logical channels and transport channels;
Multiplexing/demultiplexing of MAC SDUs;
Scheduling information reporting;
error correction through HARQ;
Priority handling between logical channels of one UE;
Priority handling between UEs by means of dynamic scheduling;
MBMS service identification;
Transport format selection; and
Padding.

The NR PHY layer 1345 or 1350 may channel-code and modulate higher layer data, and generate and transmit OFDM symbols over a radio channel, or demodulate and channel-decode OFDM symbols received over the radio channel and transmit them to a higher layer.

The radio protocol structure may be variously changed in its detailed structure depending on a carrier (or cell) operating scheme. For example, if the eNode B transmits data to the UE based on a single carrier (or cell), the eNode B and the UE use a protocol structure having a single structure for each layer such as a single cell LTE/NR 1300.

By contrast, if the eNode B transmits data to the UE based on the CA using multiple carriers in a single TRP, the eNode B and the UE use a protocol structure which has a single structure up to the RLC layer but multiplexes the PHY layer through the MAC layer as shown in CA 1310.

As yet another example, if the eNode B transmits data to the UE based on DC using multiple carriers in multiple TRPs, the eNode B and the UE use a protocol structure which has a single structure up to the RLC layer buts multiplexes the PHY layer through the MAC layer as shown in DC 1320.

Referring to the above descriptions on the PDCCH and the beam configuration, current Rel-15 and Rel-16 NR do not support the PDCCH repetitive transmission and hardly achieve the required reliability in a scenario demanding high reliability such as URLLC. The disclosure provides a PDCCH repetitive transmission method through multiple TRPs to improve PDCCH reception reliability of the UE. Details thereof will be described hereafter.

Hereafter, embodiments of the disclosure will be described in detail with reference to accompanying drawings. The content of the disclosure may be applied to frequency division duplex (FDD) and time division duplex (TDD) systems. Hereafter, higher signaling (o higher layer signaling) in the disclosure is a method of delivering a signal from a base station to a terminal by using a downlink data channel of a physical layer or from a terminal to a base station by using an uplink data channel of the physical layer, and may be referred to as RRC signaling, PDCP signaling, or MAC control element (CE).

Hereafter, the UE may determine whether to apply the cooperative communication using various methods such as applying a specific format to PDCCH(s) for allocating a PDSCH to which the cooperative communication is applied, including a specific indicator indicating whether the PDCCH(s) for allocating the PDSCH to which the cooperative communication is applied applies the cooperative communication, scrambling the PDCCH(s) for allocating the PDSCH to which the cooperative communication is applied with a specific RNTI, or assuming the cooperative communication applied in a specific interval indicated by a higher layer in the disclosure. Receiving at the UE the PDSCH to which the cooperative communication is applied based on the above similar conditions may be referred to as an NC-JT case to ease the description.

Hereafter, determining the priority between A and B in the disclosure may be variously mentioned such as selecting one having a higher priority according to a predefined priority rule and performing a corresponding operation or omitting or dropping an operation on one having a lower priority.

Hereafter, the examples are described through a plurality of embodiments in the disclosure but are not independent, and one or more embodiments may be applied simultaneously or in combination.

[Non-Coherent Joint Transmission (NC-JT)]

According to an embodiment of the disclosure, NC-JT may be used for the UE to receive PDSCHs from multiple TRPs.

Unlike the related art, the 5G wireless communication system may support a service having very short transmission delay and a service requiring high connection density as well as a service requiring a high transmission rate. In a wireless communication network including a plurality of cells, TRPs, or beams, coordinated transmission between the cells, the TRPs, and/or the beams may satisfy various service requirements by increasing a received signal strength of the UE or efficiently controlling interference between the cells, the TRPs and/or the beams.

The JT is a representative transmission technology for the above-mentioned coordinated communication, and may increase the strength or the throughput of the signal received at the UE by transmitting the signal to one UE through a plurality of different cells, TRPs and/or beams. At this time, channels between the cells, the TRPs, and/or the beam and the UE may be significantly different in characteristic, and particularly, the NC-JT supporting non-coherent precoding between the cells, the TRPs, and/or the beams may require individual precoding, modulation coding scheme (MCS), resource allocation, TCI indication, and so on, depending on the channel characteristics of each link between each cell, TRP, and/or beam and the UE.

The NC-JT may be applied to at least one channel of the downlink data channel (PDSCH), the downlink control channel (PDCCH), the uplink data channel (PUSCH), and the uplink control channel (PUCCH). Transmission information such as precoding, MCS, resource allocation, and TCI may be indicated by DL DCI in PDSCH transmission, and the transmission information may be independently indicated for each cell, TRP, and/or beam for the NC-JT transmission. This is a major factor which increases a payload required for the DL DCI transmission, which may adversely affect reception performance of the PDCCH transmitting the DCI. Hence, it is necessary to carefully design a tradeoff between the DCI amount and the control information reception performance to support the PDSCH JT.

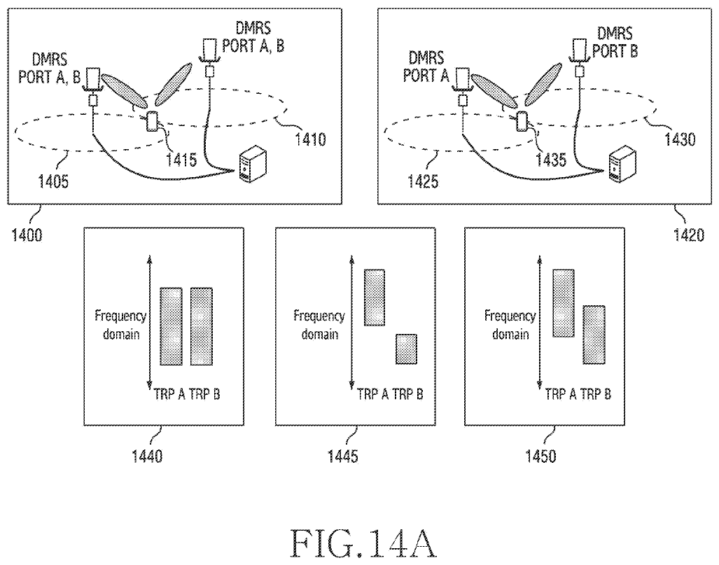

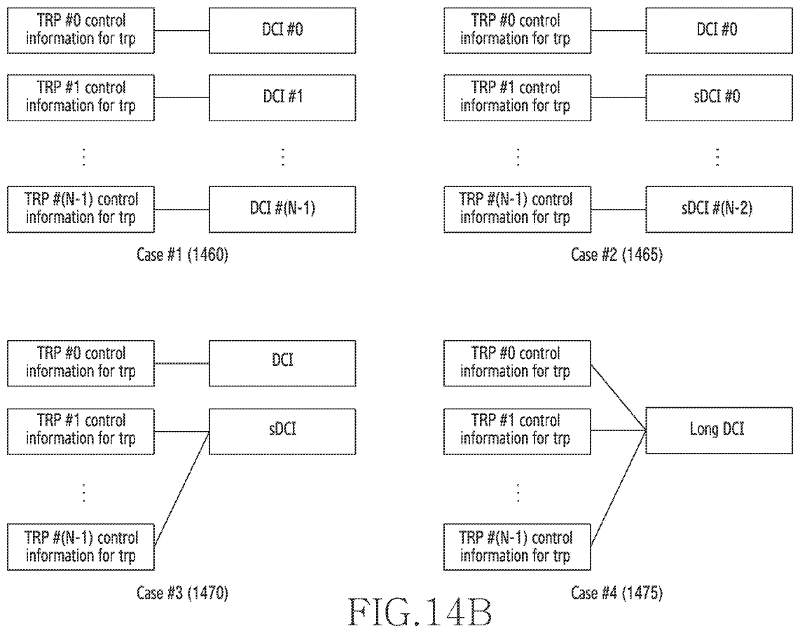

FIG. 14A illustrates an example of antenna port configuration and resource allocation for cooperative communication in a wireless communication system according to an embodiment of the present disclosure.

Referring to FIG. 14A, an example for the PDSCH transmission is described based on each JT technique, and examples for allocating radio resources per TRP are depicted.

Referring to FIG. 14A, an example 1400 of coherent joint transmission (C-JT) supporting coherent precoding between cells, TRPs and/or beams is depicted.

In the C-JT, a TRP A 1405 and a TRP B 1410 may transmit single data (PDSCH) to a UE 1415, and a plurality of TRPs may perform joint precoding. This may indicate transmitting a DMRS through the same DMRS ports such that the TRP A 1405 and the TRP B 1410 transmit the same PDSCH. For example, the TRP A 1405 and the TRP B 1410 may transmit the DRMS to the UE through a DMRS port A and a DMRS port B respectively. In this case, the UE may receive one DCI information for receiving one PDSCH demodulated based on the DMRS transmitted through the DMRS port A and the DMRS port B.

FIG. 14A shows an example 1420 of the NC-JT supporting the non-coherent precoding between cells, TRPs and/or beams for the PDSCH transmission.

The NC-JT may transmit the PDSCH to a UE 1435 for each cell, TRP and/or beam, and apply individual precoding to each PDSCH. Each cell, TRP and/or beam may transmit a different PDSCH or a different PDSCH layer to the UE, thus improving the throughput compared to single cell, TRP and/or beam transmission. In addition, each cell, TRP and/or beam may improve reliability compared to the single cell, TRP and/or beam transmission by repeatedly transmitting the same PDSCH to the UE. For convenience of description, the cell, the TRP and/or the beam may be now collectively referred to as the TRP.

Various radio resource assignments may be considered such as a case 1440 where the frequency and time resources used by a plurality of TRPs for the PDSCH transmission are all the same, a case 1445 where the frequency and time resources used by a plurality of TRPs do not overlap at all, or a case 1450 where the frequency and time resources used by a plurality of TRPs partially overlap.

For the NC-JT support, DCI of various types, structures, and relationships may be considered to allocate a plurality of PDSCHs to one UE at the same time.

FIG. 14B is a diagram illustrating a DCI configuration example for the cooperative communication in the wireless communication system according to an embodiment of the disclosure. More specifically, FIG. 14B illustrates the DCI configuration example for the NC-JT in which each TRP transmits a different PDSCH or a different PDSCH layer to the UE.

Referring to FIG. 14B, a case #1 1460 is an example in which (N−1) different PDSCHs are transmitted from (N−1) additional TRPs TRP #1 through TRP #(N−1) in addition to a serving TRP TRP #0 used in single PDSCH transmission, and control information of the PDSCHs transmitted by the (N−1) additional TRPs is transmitted independently of control information of the PDSCH transmitted from the serving TRP. That is, the UE may obtain the control information of the PDSCHs transmitted from different TRPs TRP #0 through TRP #(N−1) through independent DCI DCI #0 through DC1 #(N−1). The formats of the independent DCI may be identical or different, and the payloads of the DCI may also be identical or different. The case #1 described above may completely guarantee each PDSCH control or allocation freedom, but may degrade the reception performance due to a coverage difference between the DCI if the DCI is transmitted from the different TRP.

In a case #2 1465, (N−1) different PDSCHs are transmitted from (N−1) additional TRPs TRP #1 through TRP #(N−1) in addition to the serving TRP TRP #0 used in the single PDSCH transmission, DCI of the PDSCHs of the additional (N−1) TRPs is transmitted respectively and their DCI may be dependent on the control information of the PDSCH transmitted from the serving TRP.

For example, control information DCI #0 of the PDSCH transmitted from the serving TRP TRP #0 includes all IEs of DCI format 1_0, DCI format 1_1, and DCI format 1_2, but shortened DCI (hereafter, sDCI) sDCI #0 through sDCI #(N−2) which is the control information of the PDSCHs transmitted from the cooperative TRPs TRP #1 through TRP #(N−1) may include only some of the IEs of DCI format 1_0, DCI format 1_1, and DCI format 1_2. Hence, the sDCI transmitting the control information of the PDSCHs transmitted from the cooperative TRPs has a smaller payload than normal DCI (nDCI) transmitting the control information related to the PDSCH transmitted from the serving TRP and accordingly may include reserved bits compared to the nDCI.

The case #2 1465 may restrict each PDSCH control or allocation freedom depending on content of the IE included in the sDCI, but the reception performance of the sDCI is better than the nDCI and thus coverage difference per DCI may be less likely to occur.

In a case #3 1470, (N−1) different PDSCHs are transmitted from the additional (N−1) TRPs TRP #1 through TRP #(N−1) in addition to the serving TRP TRP #0 used in the single PDSCH transmission, one control information of the PDSCHs of the (N−1) additional TRPs is transmitted, and their DCI may be dependent on the control information of the PDSCH transmitted from the serving TRP.

For example, DCI #0 which is the control information of the PDSCH transmitted from the serving TRP TRP #0 may include all of the IEs of DCI format 1_0, DCI format 1_1, and DCI format 1_2, and the control information of the PDSCHs transmitted from the cooperative TRPs TRP #1 through TRP #(N−1) may collect and transmit only some of the IEs of DCI format 1_0, DCI format 1_1, and DCI format 1_2 in one “secondary” DCI (sDCI). For example, the sDCI may include at least one of HARQ related information such as frequency domain resource assignment, time domain resource assignment, and MCS of the cooperative TRPs. Besides, information not included in the sDCI such as a BWP indicator or a carrier indicator may conform to the DCI (DCI #0, nDCI) of the serving TRP.

The case #3 1470 may restrict each PDSCH control or allocation freedom depending on the content of the IEs included in the sDCI, but the reception performance of the sDCI may be controlled and DCI blind decoding complexity of the UE may be reduced compared to the case #1 1460 or the case #2 1465.

A case #4 1475 shows an example in which the (N−1) different PDSCHs are transmitted from the (N−1) additional TRPs TRP #1 through TRP #(N−1) in addition to the serving TRP TRP #0 used in the single PDSCH transmission, and the control information of the PDSCHs transmitted from the (N−1) additional TRPs are transmitted in the same DCI (long DCI) as the control information of the PDSCH transmitted from the serving TRP. That is, the UE may obtain the control information of the PDSCHs transmitted from the different TRPs TRP #0 through TRP #(N−1) through the single DCI. In the case #4 1475, the DCI blind decoding complexity of the UE may not increase, but the PDSCH control or allocation freedom may be lowered such as limiting the number of cooperative TRPs according to long DCI payload restriction.

In the following description and embodiments, the sDCI may indicate various auxiliary DCIs such as the shortened DCI, the secondary DCI, or the normal DCI (e.g., DCI formats 1_0 through 1_1) including the PDSCH control information transmitted from the cooperative TRP, and the corresponding description may be applied to various auxiliary DCIs in a similar manner unless a specific restriction is specified.

In the following description and embodiments, the aforementioned case #1 1460, case #2 1465, and case #3 1470 which use one or more DCI (PDCCHs) to the support the NC-JT may be distinguished as the multiple PDCCH based NC-JT, and the aforementioned case #4 1475 which uses the single DCI (PDCCH) to support the NC-JT may be distinguished as the single PDCCH based NC-JT. In the multiple PDCCH based PDSCH transmission may distinguish a CORESET scheduling the DCI of the serving TRP TRP #0 and a CORESET scheduling the DCI of the cooperative TRPs TRP #1 through TRP #(N−1). A method of distinguishing the CORESETs may include a method of distinguishing the CORESETs using a higher layer indicator per CORESET, a method of distinguishing the CORESETs using beam configuration per CORESET, and the like. In addition, in the single PDCCH based NC-JT, the single DCI may schedule the single PDSCH having a plurality of layers, instead of scheduling a plurality of PDSCHs, and the plurality of the layers mentioned above may be transmitted from a plurality of TRPs. A connection relationship between the layer and the TRP transmitting the corresponding layer may be indicated through transmission configuration indicator (TCI) indication for the layer.

The “cooperative TRP” in the embodiments of the disclosure may be replaced by various terms such as a “cooperative panel” or a “cooperative beam” in actual application.

In the embodiments of the disclosure, “applying the NC-JT” may be variously construed depending on a situation such as “a case where the UE simultaneously receives one or more PDSCHs in one BWP,” “a case where the UE simultaneously receives PDSCHs based on two or more TCIs in one BWP,” or “a case where the PDSCH received at the UE is associated with one or more DMRS port groups,” but one expression is used for convenience of explanation.

In the disclosure, the wireless protocol structure for the NC-JT may be used in various manners according to a TRP deployment scenario. For example, if there is no or small backhaul delay between the cooperative TRPs, a method (a CA-like method) using a structure based on MAC layer multiplexing similarly to the CA 1310 of FIG. 13 is possible. By contrast, if the backhaul delay between the cooperative TRPs is too considerable to ignore (e.g., if information exchange such as CSI, scheduling, HARQ-ACK between the cooperative TRPs requires a time over 2 ms), a method (a DC-like method) of securing characteristics robust to delay using an independent structure per TRP from the RLC layer, similarly to the DC 1320 of FIG. 13 is possible.

The UE supporting the C-JT/NC-JT may receive C-JT/NC-JT-related parameters or setting values from the higher layer configuration, and accordingly set RRC parameters of the UE. For the higher layer configuration, the UE may utilize a UE capability parameter, for example, tci-StatePDSCH. Herein, the UE capability parameter, for example, tci-StatePDSCH may define the TCI states for the sake of the PDSCH transmission, the number of the TCI states may be set to 4, 8, 16, 32, 64, and 128 in FR1 and to 64 and 128 in FR2, and up to 8 states indicated with TCI field 3 bits of the DCI through the MAC CE message may be configured among the configured numbers. The maximum value 128 indicates a value indicated by maxNumberConfiguredTCIstatesPerCC in the parameter tci-StatePDSCH included in UE capability signaling. As such, the series of the configuration procedures from the higher layer configuration to the MAC CE configuration may be applied to beamforming indication or beamforming change command for at least one PDSCH in one TRP.

### First Embodiment: Multi-TRP Based PDCCH Repetitive Transmission Method

As an embodiment of the disclosure, the PDCCH repetitive transmission method in consideration of the multi-TRP is explained. The PDCCH repetitive transmission method in consideration of the multi-TRP may include various methods depending on how to apply each TCI state to apply to the PDCCH transmission at each TRP, to various parameters used for the PDCCH transmission. For example, various parameters used for the PDCCH transmission to apply different TCI states may include the CCE, the PDCCH candidates, the CORESET, the search space, and the like. In the PDCCH repetitive transmission method considering the multi-TRP, the UE reception may consider soft combining, selection and so on.

The multi-TRP based PDCCH repetitive transmission may have the following five methods, and the eNode B may configure or indicate at least one of the five methods to the UE through the high layer signaling, the L1 signaling, or a combination of the high layer signaling and the L1 signaling.

[Method 1-1] Method for Repetitively Transmitting a Plurality of PDCCHs Having the Same Payload

The method 1-1 is a method for repetitively transmitting a plurality of control information with the same DCI format and payload. Each control information may indicate information for scheduling the repetitively transmitted PDSCH, for example, {PDSCH #1, PDSCH #2, . . . , PDSCH #Y} repetitively transmitted over a plurality of slots. The same payload in the control information repetitively transmitted may indicate that PDSCH scheduling information of each control information, for example, the number of repeated PDSCH transmissions, time domain PDSCH resource allocation information, that is, the slot offset (K_0) between the control information and the PDSCH #1 and the number of PDSCH symbols, frequency domain PDSCH resource allocation information, DMRS port allocation information, PDSCH-to-HARQ-ACK timing, PUCCH resource indicator, and so on are all the same. The UE may improve control information reception reliability by soft combining the repetitively transmitted control information having the same payload.

For the soft combining, the UE may need to know in advance a resource location of the repetitively transmitted control information and the number of the repetitive transmissions. For doing so, the eNode B may indicate in advance time domain, frequency domain, spatial domain resource configuration of the repetition transmission control information. If the control information is repetitively transmitted in the time domain, the control information may be repetitively transmitted over different CORESETs, over different search space sets within one CORESET, or over different PDCCH monitoring occasions within one CORESET and one search space set. The resource unit (CORESET unit, search space set unit, PDCCH monitoring occasion unit) repetitively transmitted in the time domain and the repetitive transmission resource location (PDCCH candidate index, etc.) may be indicated through high layer configuration (e.g., RRC signaling) of the eNode B. In this case, the number of the PDCCH repetitive transmissions and/or a TRP list participating in the repetitive transmission and a transmission pattern may be explicitly indicated, and the explicit indication may use the higher layer indication or MAC-/L1 signaling. The TRP list may be indicated in the form of the TCI state or the QCL assumption.

If the control information is repetitively transmitted in the frequency domain, the control information may be repetitively transmitted over different CORESETs, over different PDCCH candidates within one CORESET, or per CCE. The resource unit repetitively transmitted in the frequency domain and the repetitive transmission resource location may be indicated through the high layer configuration of the eNode B. The number of the PDCCH repetitive transmissions and/or the TRP list of the repetitive transmission and the transmission pattern may be explicitly indicated, and the explicit indication may use the higher layer indication or the MAC-/L 1 signaling. The TRP list may be indicated in the form of the TCI state or the QCL assumption.

If the control information is repetitively transmitted in the spatial domain, the control information may be repetitively transmitted over different CORESETs, or by configuring a plurality of TCI states within one CORESET.

As an embodiment of the disclosure, the method of the base station for repetitively transmitting the PDCCH is explained. The DCI including the PUSCH or PDSCH scheduling information may be transmitted from the base station to the terminal over the PDCCH in the wireless communication system.

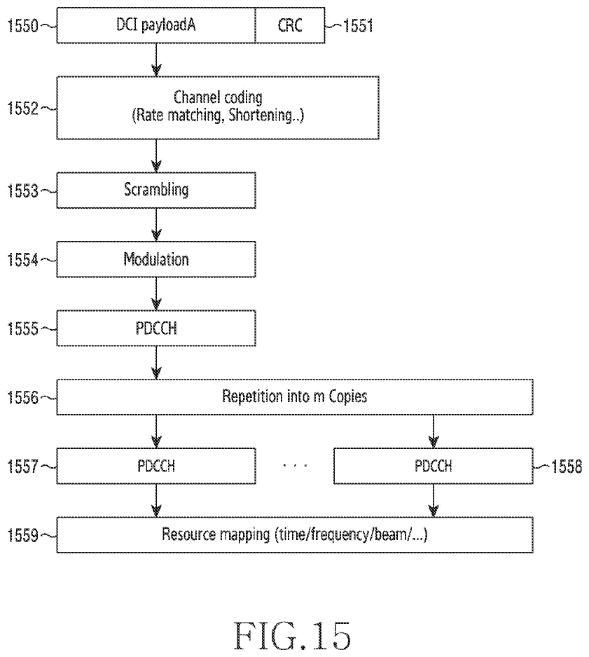

FIG. 15 illustrates generating a PDCCH repetitively transmitted according to an embodiment of the present disclosure.

In operation 1550, the base station may generate DCI. CRC 1551 may be attached to a DCI payload of the DCI generated by the base station.

In operation 1552, the generated DCI may generate a PDCCH 1555 through channel coding, scrambling 1553 and modulation 1554. The base station may copy the generated PDCCH into a plurality of PDCCHs in operation 1556, and transmit them using a specific resource (e.g., time, frequency, transmit beam, etc.) in operation 1559. That is, coded bits for the PDCCH repetitively transmitted at each TRP may be identical. As such, for the same coded bits, an information value for each DCI field in the PDCCH may be set to the same value. For example, every field (e.g., time domain resource allocation (TDRA), frequency domain resource allocation (FDRA), TCI, antenna ports, etc.) in the DCI information may be set to the same value. Herein, the same value may be interpreted as one meaning in general but may be interpreted as multiple meanings if connoting or corresponding to a plurality of (e.g., two) values as above according to a specific configuration. A detailed description thereof is described below.

As shown in FIG. 15, for example, if the base station repetitively transmits the PDCCH twice (e.g., m=2), the base station may map the PDCCHs to a TRP A and a TRP B respectively and thus repetitively transmit the PDCCH based on the same beam or different beams in terms of the spatial domain. In so doing, the base station may perform the PDCCH repetitive transmission based on CORESETs linked to two search spaces explicated linked with higher layer signaling. The base station may perform the PDCCH repetitive transmission based on a single TRP if the CORESETs linked to the search spaces are the same, or if the TCI states of the CORESETs are the same. The base station may perform the PDCCH repetitive transmission based on the multi-TRP, if the CORESETs linked to the search spaces are different, or if the TCI states of the CORESETs are different. If the base station repetitively transmits the PDCCH four times, the base station may map two PDCCHs to the TRP A and the TRP B each, wherein the two PDCCHs mapped to each TRP may be separately transmitted in the time domain. The PDCCH repetitive transmission separated in the time domain may be repeated in a slot based, subslot based or mini-slot based time unit.

Notably, the above method is merely exemplary and the disclosure is not limited thereto. The terminal and the base station may consider the following methods for the PDCCH repetition in the disclosure:
PDCCH repetition in the same CORESET and in the same slot in terms of the time/frequency/spatial domain,
PDCCH repetition in the same CORESET between different slots in terms of the time/frequency/spatial domain;
PDCCH repetition between different CORESETs within the same slot in terms of the time/frequency/spatial domain; and
PDCCH repetition between different CORESETs and between different slots in terms of the time/frequency/spatial domain.

If CORESETPoolindex is set, PDCCH repetition may be considered per CORESETPoolindex in addition to CORESET. The number of PDCCH repetitions may increase independently, and accordingly the above methods may be considered in combination at the same time.

The base station may preset information of which domain the PDCCH is repeatedly transmitted through to the terminal through the RRC message. For example, in the PDCCH repetition transmission in terms of the time domain, the base station may preset information whether the repetition transmission is based on at least one of the slot based, subslot based, or mini-slot based time unit to the terminal. In the PDCCH repetition transmission in terms of the frequency domain, the base station may preset information of whether the repetition is based on at least one of the CORESET, the BWP, or a component carrier (CC) to the terminal. In the PDCCH repetition transmission in terms of the spatial domain, the base station may preset beam information for the PDCCH repetition transmission to the terminal through configuration for each QCL type. Alternatively, the base station may combine and transmit the information listed above to the terminal through an RRC message. Hence, the base station may repetitively transmit the PDCCH according to the preset information through the RRC message, and the terminal may repetitively receive the PDCCH according to the preset information through the RRC message.

[Method 1-2] Method for Repetitively Transmitting a Plurality of Control Information Having Different DCI Formats and/or Payloads

The method 1-2 is a method for repetitively transmitting a plurality of control information which may have different DCI format and/or payloads. The control information may be used to schedule the repetition transmission PDSCH, and the number of PDSCH repetition transmissions indicated by each control information may differ. For example, PDCCH #1 may indicate information for scheduling {PDSCH #1, PDSCH #2, . . . , PDSCH #Y}. By contrast, PDCCH #2 may indicate information for scheduling {PDSCH #2, . . . , PDSCH #Y}, . . . , and PDCCH #X may indicate information for scheduling {PDSCH Y}. As such, the method 1-2 may reduce total latency required for the control information and the PDSCH repetition transmission compared to the method 1-1. Since the payload of each control information repetitively transmitted may differ, the method 1-2, which may not soft combine the control information repetitively transmitted, may exhibit lower reliability than the method 1-1.

In the method 1-2, the terminal may not need to know in advance the resource location of the control information repetitively transmitted and the number of the repetition transmissions, and may independently decode and process each control information repetitively transmitted. If decoding a plurality of repetition transmission control information which schedules the same PDSCH, the terminal may process only the first repetition transmission control information and ignore repetition transmission control information after the second information. Alternatively, the resource location of the control information repetitively transmitted and the number of the repetition transmissions may be indicated in advance, and the indication method may be the same as described in the method 1-1.

[Method 1-3] Method for Repetitively Transmitting a Plurality of Control Information Having Different DCI Formats and/or Payloads

The method 1-3 is a method for repetitively transmitting a plurality of control information which may have different DCI formats and/or payloads. Each control information has the same DCI format and payload. Since the plurality of the control information may not be soft combined in the method 1-2, the reliability may be lower than the method 1-1, and the method 1-1 may increase the total latency required for the control information and the PDSCH repetition transmission. The method 1-3, which uses the advantages of the method 1-1 and the method 1-2, may reduce the total latency required for the control information and the PDSCH repetition transmission compared to the method 1-1 and transmit the control information with higher reliability than the method 1-2.

The method 1-3 may use the soft combining of the method 1-1 and the individual decoding of the method 1-2, to decode and soft combine the repetitively transmitted control information. For example, in the repetition transmission of the plurality of the control information which may have different DCI formats and/or payloads, the first control information transmitted may be decoded as in the method 1-2, and the repetition transmission of the decoded control information may be soft combined as in the method 1-1.

Meanwhile, the base station may select and configure one of the method 1-1, the method 1-2 or the method 1-3 for the control information repetition transmission. The base station may explicitly indicate the control information repetition transmission scheme to the terminal through higher layer signaling. Alternatively, the control information repetition transmission scheme may be indicated in combination with other configuration information. For example, higher layer configuration indicating the PDSCH repetition transmission scheme may be combined with the control information repetition transmission indication. For example, if it is indicated to repetitively transmit the PDSCH in the FDM manner, it may be interpreted to repetitively transmit the control information using only the method 1-1. This is because the PDSCH repetition transmission in the FDM manner exhibits no latency reduction effect of the method 1-2. Likewise, if it is indicated to repetitively transmit the PDSCH in an intra-slot time division multiplexing (TDM) manner, it may be interpreted to repetitively transmit the control information using the method 1-1. By contrast, if it is indicated to repetitively transmit the PDSCH in an inter-slot TDM manner, the method 1-1, the method 1-2 or the method 1-3 for the control information repetition transmission may be selected through higher layer signaling or L1 signaling.

The base station may explicitly indicate the control information repetition transmission unit to the terminal through configuration such as higher layer. Alternatively, control information repetition transmission unit may be indicated in combination with other configuration information. For example, higher layer configuration indicating the PDSCH repetition transmission scheme may be combined with the control information repetition transmission unit. If it is indicated to repetitively transmit the PDSCH in the FDM manner, it may be interpreted to repetitively transmit the control information using the FDM or spatial division multiplexing (SDM). This is because there is no latency reduction effect of the FDM based PDSCH repetition transmission if the control information is repetitively transmitted in the inter-slot TDM manner. Likewise, if it is indicated to repetitively transmit the PDSCH in the intra-slot TDM manner, it may be interpreted to repetitively transmit the control information using the intra-slot TDM, FDM or SDM. By contrast, if it is indicated to repetitively transmit the PDSCH in the inter-slot TDM manner, higher layer signaling may select to repetitively transmit the control information using the inter-slot TDM, or the intra-slot TDM, FDM or SDM.

[Method 1-4] PDCCH Transmission Applying Each TCI State to a Different CCE of the Same PDCCH Candidate Group

The method 1-4 may transmit CCEs by applying different TCI states indicating transmission from a multi-TRP to different CCEs of the PDCCH candidate group for the sake of the PDCCH reception performance enhancement without PDCCH repetition transmission. Since each TRP transmits the different CCE in the PDCCH candidate group by applying the different TCI state, the method 1-4, which is not the PDCCH repetition transmission, may obtain spatial diversity in the PDCCH candidate group. The different CCE applying the different TCI state may be separated in the time or frequency dimension, and the terminal may need to know in advance the resource location applying the different TCI state. The terminal may receive different CCEs applying the different TCI states in the same PDCCH candidate group and decode them independently or all together.

[Method 1-5] PDCCH Transmission Applying a Plurality of TCI States to all CCEs in the Same PDCCH Candidate Group (SFN Scheme)

The method 1-5 may transmit CCEs in a single frequency network (SFN) manner by applying a plurality of TCI states to all CCEs of the PDCCH candidate group for the sake of the PDCCH reception performance enhancement without PDCCH repetition transmission. The method 1-5, which is not the PDCCH repetition transmission, may obtain the spatial diversity through the SFN transmission at the same CCE location in the PDCCH candidate group. The terminal may receive CCEs of the same location applying different TCI states in the same PDCCH candidate group and decode them independently or all together by using some or all of the TCI states.

### Second Embodiment: Soft Combining Related UE Capability Report in PDCCH Repetition Transmission

The terminal may report soft combining related UE capability in the PDCCH repetition transmission to the base station. The UE capability reporting may include several methods. Specific methods are as follows.

[UE capability reporting method 1] The terminal may report the UE capability of whether the soft combining is possible or not in the PDCCH repetition transmission to the base station.

For example, if the terminal reports as the UE capability, information of the soft combining possible in the PDCCH repetition transmission to the base station, the base station may determine the soft combining of the terminal as the most flexible level (e.g., determine that the terminal may soft combine at a log likelihood ratio (LLR) level), and most flexibly notify the terminal of PDCCH repetition transmission related configuration in the PDCCH repetition transmission configuration. In so doing, as an example of the PDCCH repetition transmission configuration, the base station may notify the corresponding configuration to the terminal by assuming that soft combining between CORESETs or search spaces having different configurations, soft combining between PDCCH candidates in the same aggregation level, or soft combining between PDCCH candidates between different aggregation levels is possible.

As another example, if the terminal reports as the UE capability, information of the soft combining possible in the PDCCH repetition transmission to the base station, the base station may determine the soft combining of the UE most conservatively (e.g., determine that the terminal may soft combine at an OFDM symbol level), and most limitedly notify the terminal of PDCCH repetition transmission related configuration in the PDCCH repetition transmission configuration. In so doing, as an example of the PDCCH repetition transmission configuration, the base station may notify the corresponding configuration to the terminal by assuming that soft combining between a plurality of CORESETs having the same configuration or soft combining between PDCCH candidates at the same aggregation level is possible.

[UE capability reporting method 2] To represent the soft combining operation available at the terminal as the UE capability more specifically than the UE capability reporting method 1, the terminal may report the UE capability by dividing the soft combining into levels in the PDCCH repetition transmission to the base station. That is, the terminal may identify a signal level to adopt the soft combining with respect to the PDCCH repetition transmission among signal levels generated from the reception operation processes of the terminal, and report information related to the signal level for adopting the soft combining with respect to the PDCCH repetition transmission as the UE capability to the base station. For example, the terminal may inform of the soft combining available at the OFDM symbol level, inform of the soft combining available at the modulation symbol level, and inform of the soft combining available at the LLR level as the signal level for adopting the soft combining. Depending on each signal level reported by the terminal, the base station may notify adequate configuration for the terminal to perform the soft combining according to the reported UE capability.

[UE capability reporting method 3] The terminal may transmit to the base station through the UE capability, restriction required to allow the soft combining at the terminal in the PDCCH repetition transmission. For example, the terminal may report to the base station the same CORESET configuration included in the repeated PDCCH. As another example, the terminal may report to the base station at least the same aggregation level of the repeated PDCCH candidates.

[UE capability reporting method 4] The terminal may report through the UE capability, which PDCCH repetition transmission scheme is supported if receiving the PDCCH repetition transmission from the base station. For example, the terminal may report the method 1-5 (SFN transmission scheme) support to the base station. As another example, the terminal may report the intra-slot TDM or the inter-slot TDM or FDM support of the method 1-1 (e.g., the multi-PDCCH repetition transmission method having the same payload) to the base station. Particularly, in the TDM, the terminal may report a maximum time interval value between the repeated PDCCHs to the base station. For example, the terminal may report the maximum time interval value between the repeated PDCCHs as 4 OFDM symbols to the base station. In this case, if performing the TDM based PDCCH repetition transmission on the terminal, the base station may adjust the time interval value between the repeated PDCCHs to be below 4 OFDM symbols based on the corresponding information.

[UE capability reporting method 5] The terminal may report to the base station through the UE capability, the number of blind decodings consumed if receiving the PDCCH repetition transmission from the base station. For example, the terminal may report the number of the blind decodings consumed in receiving the PDCCH repetition transmission as 1, 2 or 3 to the base station regardless of the reception method of the terminal (e.g., individual decoding, soft combining, other reception schemes, or a combination thereof). The base station may assume that the terminal consumes the blind decodings reported if receiving the PDCCH repetition transmission, and transmit search space and CORESET configurations to the terminal within the slot or the span not to exceed the maximum blind decoding count of the terminal.

A combination of two or more UE capability reporting methods may be configured in actual application. For example, the terminal may report the soft combing possible at the LLR level according to [UE capability reporting method 2], concurrently report at least the same aggregation level of the PDCCH candidates repeated by [UE capability reporting method 3], support the TDM PDCCH repetition transmission according to [UE capability reporting method 4], and report the maximum time interval value between two repeated PDCCHs as 4 OFDM symbols to the base station. Besides, applications based on various combinations of the UE capability reporting methods are possible but detailed description thereof shall be omitted.

### Third Embodiment: PDCCH Repetition Transmission and Explicit Linkage Related Configuration Method

As an embodiment of the disclosure, a PDCCH repetition transmission configuration method for enabling the soft combining in the PDCCH repetition transmission is described. If performing the PDCCH repetition transmission on the terminal based on the method 1-1 (the multi-PDCCH repetition transmission method with the same payload) among the various PDCCH repetition transmission methods, the base station may be configured or indicated with information of explicit linkage or association between the repeated PDCCH candidates through the higher layer signaling, the L1 signaling, or a combination of the higher layer signaling or the L1 signaling, to reduce the blind decoding count in consideration of the soft combining of the terminal. The PDCCH repetition transmission and explicit linkage related configuration method with the higher layer signaling may include various methods as below.

[PDCCH repetition configuration method 1] If configuration information exists in higher layer signaling PDCCH-config

For the PDCCH repetition transmission and explicit linkage related configuration method, the base station may configure PDCCH-repetition-config in higher layer signaling PDCCH-config to the terminal, and PDCCH-repetition-config may include the following information:
PDCCH repeat transmission scheme—one of TDM, FDM, SFN;
CORESET-search space combination(s) to be used in PDCCH repetition transmission;
CORESET index(es)—OPTIONAL, and
search space index(es)—OPTIONAL;
aggregation level(s) for explicit linkage—OPTIONAL;
PDCCH candidate index(s) for explicit linkage—OPTIONAL; and
Frequency resources for explicit linkage—OPTIONAL.

Based on at least one of the above information, the base station may configure the PDCCH repetition transmission to the terminal through the higher layer signaling. For example, if the PDCCH repetition transmission scheme is set to the SFN, the CORESET index is set to 1 as the CORESET-search space combination to be used in the PDCCH repetition transmission, and the search space index is not set, the terminal may expect that the PDCCH is repeatedly transmitted using the method 1-5 (SFN transmission scheme) in the CORESET having the index 1. At this time, the configured CORESET may be configured and/or indicated with one or more different TCI states through the higher layer signaling, the L1 signaling or the MAC-CE signaling, or a combination of the higher layer signaling and the L1 signaling or the MAC-CE signaling. In addition, if the PDCCH repetition transmission scheme is set to the SFN, the terminal may not expect the search space index configured in the CORESET-search space combination to be used in the PDCCH repetition transmission.

As another example, the PDCCH repetition transmission scheme may be set to the TDM or the FDM, and two CORESET-search space combinations to be used in the PDCCH repetition transmission may be configured. For example, if the CORESET index 1 and the search space index 1 are set for a first combination, and the CORESET index 2 and the search space index 2 is set for a second combination, the terminal may expect that the PDCCH is repeatedly transmitted in the TDM or FDM manner using the method 1-1 using two CORESET-search space combinations. At this time, each CORESET configured may be configured and/or indicated with a plurality of identical or different TCI states through the higher layer signaling, the L1 signaling or the MAC-CE signaling, or a combination of the higher layer signaling and the L1 signaling or the MAC-CE signaling. In addition, if the PDCCH repetition transmission scheme is set to the TDM or the FDM, the terminal may expect that up to two CORESET-search space combinations to be used in the PDCCH repetition transmission are configured, and the CORESET and search space indexes are set in each combination.

According to an embodiment, five information for the PDCCH repetition transmission and explicit linkage related configuration may be updated based on the MAC-CE without RRC reconfiguration. If the base station does not set PDCCH-repetition-config to the terminal, the terminal does not expect the PDCCH to be repeatedly transmitted but may expect only a single PDCCH transmission. The aggregation level, the PDCCH candidate index, and frequency resources for the explicit linkage may not all be configured, or at least one of them may be configured according to the explicit linkage method to be described.

[PDCCH Repetition Configuration Method 2] if Configuration Information Exists in Higher Layer Signaling for Search Space

The base station may notify the terminal by adding higher layer signaling into searchSpace which is higher layer signaling of the search space for the PDCCH repetition transmission. For example, a parameter repetition which is the additional higher layer signaling may be set to on or off in the higher layer signaling searchSpace, to configure that the corresponding search space is used for the repetition transmission. A search space where Repetition is set to on may be one or two per BWP. For example, if searchSpaceId is set to 1, controlResourceSetId is set to 1, and repetition is set to on in the higher layer signaling searchSpace for the search space index 1, the terminal may expect the PDCCH repetition transmission performed according to the method 1-5 (SFN transmission method) in the CORESET 1 linked to the search space 1. As another example, if searchSpaceId is set to 1, controlResourceSetId is set to 1 and repetition is set to on in the higher layer signaling searchSpace for the search space index 1, and searchSpaceId is set to 2, controlResourceSetId is set to 2 and repetition is set to on in the higher layer signaling searchSpace for the search space index 2, the terminal may obtain that the PDCCH repetition transmission is performed with the TDM or the FDM using the method 1-1 between the combination of the CORESET 1+search space 1 and the combination of the CORESET 2+search space 2. The TDM and the FDM may be divided according to time and frequency settings through the higher layer signaling of the CORESETs 1 and 2 and the search spaces 1 and 2 respectively. Also, in the higher layer signaling for the search space in which repetition is set to on, the aggregation level or the PDCCH candidate indexes for the explicit linkage described in [PDCCH repetition configuration method 1] may be set. In addition, neither of, either of, or both of the aggregation level or the PDCCH candidate indexes for the explicit linkage may be configured according to an explicit linkage method to be described.

[PDCCH Repetition Configuration Method 3] if Linkage Configuration Exists Between Two Search Spaces

As yet another PDCCH repetition configuration method, the base station may allocate SearchSpaceLinkingId to each search space for the PDCCH repetition transmission of the terminal, and the terminal may perform PDCCH reception repeated using two search spaces, by regarding that the two search spaces having the same SearchSpaceLinkingId are explicitly linked with higher layer signaling. In addition, the search spaces having the same SearchSpaceLinkingId may be limited two, may have the same search space type and the DCI format for monitoring, may have all the same value for monitoringSlotPeriodicityAndOffset indicating the search space period and the slot offset, monitoringSymbolsWithinSlot indicating the monitoring occasion in the slot, and duration configuration information indicating the number of slots to consecutively monitor in the set period, may have the same number of PDCCH candidates for a specific aggregation level (AL), and may have the same number of monitoring occasions (Mos) in a specific slot. In addition, the two repeated PDCCHs may have the same AL and the same PDCCH candidate index, and allow only the repetitive transmission in the slot.

For example, if SearchSpaceLinkingId is set to 1 for a first search space and a second search space, the two search spaces are the same UE-specific search spaces, monitoring DCI formats 0_1 and 1_1 is allowed, monitoringSlotPeriodicityAndOffset indicating the search space period and the slot offset, monitoringSymbolsWithinSlot indicating the monitoring occasion in the slot, and the duration configuration information indicating the number of the slots to consecutively monitor in the set period have the same value, and two PDCCH candidates are for AL2, the terminal may assume and receive repetition transmission between first PDCCH candidates for the AL2 transmitted in the two search spaces, and assume and receive repetition transmission between second PDCCH candidates for the AL2 transmitted in the two search spaces.

### Fourth Embodiment: DL CORESET Configuration Method in Broadband Unlicensed Band

In the NR or 5G communication system, the base station or the terminal may transmit and receive signals in a broadband unlicensed band, and the broadband unlicensed band may be configured on the subband (e.g., 20 MHz) basis. The base station and the terminal may perform a channel access procedure on the subband basis to occupy the unlicensed band, and perform the configured signal transmission reception, by accessing the unlicensed band in at least one of every subband, one subband or consecutive subbands in an idle state according to a result of the channel access procedure. Meanwhile, since the DL control channel region (CORESET or search space) is set for each BWP in the NR system, if an available subband is changed according to the channel access procedure result, the PDCCH monitoring candidates may be omitted. Hence, unlike the NR system, the DL CORESET configuration for the broadband unlicensed band needs to change in a manner considering the subband. The disclosure provides a method and an apparatus for indicating (or changing, adjusting) control channel region configuration information by considering subbands, and changing or adjusting DL control channel region configuration information using a channel access procedure result.

Hereafter, the method and the apparatus suggested in the embodiments of the disclosure are not limited to and applied to each embodiment, and may be utilized for a method and an apparatus for configuring or determining the control channel region for the PDCCH monitoring or search using all of one or more embodiments suggested in the disclosure or a combination of some embodiments. In addition, the embodiment of the disclosure explains that the base station configures the control channel region in the subband-based broadband unlicensed band by way of example, which is exemplary, and may be also applied for configuring the control channel region in a broadband system such as multi-carrier or carrier aggregation transmission. Further, it may be applicable to configure the control channel region in a single carrier or single band system besides the broadband. Besides, in the embodiment of the disclosure describes by assuming the base station and the terminal operating in the unlicensed band, but the method and the apparatus provided in the embodiment of the disclosure may be also applied to a base station and a terminal operating in a licensed band or a shared spectrum, as well as the unlicensed band.

The embodiment provides a method of the base station for configuring DL CORESET to the terminal in the broadband unlicensed band. More specifically, the CORESET configured in the BWP may be included in a specific subband, and other subband may also use the same CORESET configuration information of the specific subband.

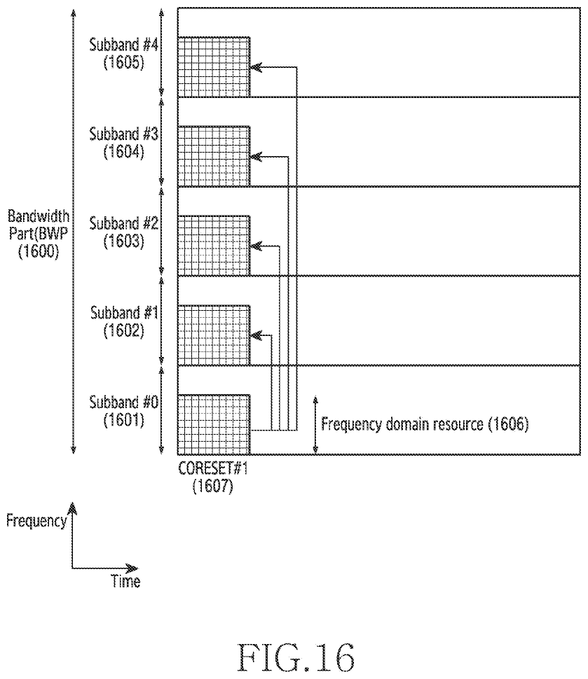

FIG. 16 illustrates a CORESET configuration method according to an embodiment of the present disclosure.

Referring to FIG. 16, it is assumed that, in the base station and the terminal transmitting and receiving signals in the broadband unlicensed band, the base station is configured to perform the channel access procedure based on the subband, and then to perform PDCCH/PDSCH transmission by accessing an idle subband according to a result of the channel access procedure. The accessible subband of the unlicensed band may indicate at least one or more idle subbands. The base station may configure a CORESET 1607 in a BWP 1600. In so doing, the configured CORESET may be included only in a specific subband 1601. Herein, the specific subband 1601 may be a reference subband.

According to an embodiment, the reference subband may be determined or configured with the lowest subband index, a subband index including an SS/PBCH block, a subband index including a CORESET #0, or a subband index including the lowest PRB/CRB. Alternatively, the base station may configure the subband index to the terminal through the higher layer signal or the control channel. CORESET information of other subbands 1602 through 1605 than the reference subband may be the same as the CORESET configuration information included in the reference subband. In this case, the CORESET index applied to each subband may be identical, and the number of PDCCH candidates may be set within the maximum number of PDCCH candidates.

According to an embodiment, the base station and the terminal may differently interpret higher layer signaling frequencyDomainResources indicating frequency resource allocation information of the CORESET, depending on the search space linked to the corresponding CORESET. If a specific CORESET is linked to a specific search space and higher layer signaling freqMonitorLocations of whether each subband includes the CORESET is not set in higher layer signaling of the corresponding search space, the terminal may use existing definition of frequencyDomainResources. That is, the terminal may be configured with the frequency resource allocation information of the CORESET by use of 45 bits in total each indicating frequency resource allocation for six RBs. By contrast, if a specific CORESET is linked to a specific search space and the higher layer signaling freqMonitorLocations of whether each subband includes the CORESET is set in the higher layer signaling of the corresponding search space, the terminal may use new definition considering a plurality of subbands, instead of the existing definition of frequencyDomainResources. The terminal may regard bitmap information corresponding to a first subband of frequencyDomainResources as frequency resource allocation information 1606 of the first subband, and further obtain frequency resource allocation information of each subband using freqMonitorLocations in the higher layer signaling of the search space.

For example, freqMonitorLocations may be a 5-bit bitmap. If a specific bit value of the bitmap 5 bits is 1, the bit value may indicate the frequency resource allocation of the CORESET in the corresponding subband. That is, the frequency resource allocation information obtained using the new definition of frequencyDomainResources may be identically applied to the corresponding subband with respect to the subband location of which the value freqMonitorLocations is 1. Namely, the frequency resource allocation information of the first subband of the corresponding CORESET may be identically copied (applied) to the subband location of which the value freqMonitorLocations is 1. freqMonitorLocations is the 5-bit bitmap by way of example, and may be configured with a bit map including less or more bits than five bits.

### Fifth Embodiment: PDCCH Repetition Transmission Configuration Method in Broadband Unlicensed Band

As an embodiment of the disclosure, the PDCCH repetition transmission configuration method in the broadband unlicensed band is explained. The PDCCH repetition transmission may be used also in the unlicensed band. If a channel is occupied by succeeding in the channel access procedure in the unlicensed band and then the corresponding channel is not used for a specific time, that is, if UL transmission and DL reception are not conducted in the corresponding channel for the specific time, or if a designated channel occupation time (COT) passes after the successful channel access procedure, the channel access procedure needs to be additionally performed to occupy the channel again. To avoid such unnecessary channel access procedures, a consecutive channel occupation scheme based on time may be required. At this time, the COT may be configured through the higher layer signaling, activated through the MAC-CE, dynamically indicated through the DCI, notified through a combination thereof, or predefined for each specific unlicensed band. For the PDCCH not scheduling the PDSCH, the terminal may have no PDSCHs to consecutively receive based on time after the PDCCH reception, and accordingly the repetitive PDCCH reception may be effective to increase the COT. In addition, if the base station and the terminal use the unlicensed band of a high frequency such as 60 GHz and the PDCCH reception is not possible due to receive beam blockage from the base station, such a problem may be addressed using the PDCCH repetition transmission from multiple TRPs.

If considering the PDCCH repetition transmission in the unlicensed band, the base station and the terminal may need to consider both the frequency resource allocation method of the CORESET considering the plurality of the subbands and the PDCCH repetition transmission configuration information. The unlicensed band needs to use two search spaces linked with the higher layer signaling in the PDCCH repetition transmission, and may consider the frequency resource allocation method of the CORESET considering the plurality of the subbands for the PDCCH reception in the unlicensed band. In so doing, the following methods may be used for necessary restrictions and additional interpretation if the configuration information of the two schemes are combined.

[Method 5-1]

If the base station and the terminal consider the PDCCH repetition transmission in the unlicensed band, the base station may notify the terminal to link two search spaces having the same CORESET frequency resource allocation information in each subband with the higher layer signaling and to use them for the PDCCH repetition transmission. Specifically, the base station may configure the same SearchSpaceLinkingId for the terminal with respect to the two search spaces having the same freqMonitorLocations configuration information. The terminal may not expect the same SearchSpaceLinkingId configuration for the two search spaces having different freqMonitorLocations configuration information.

In the method 5-1, if the base station and the terminal succeed in the channel access procedure of a specific subband and the corresponding subband has the frequency resource allocation of each CORESET linked to the two search spaces according to freqMonitorLocations configuration information of the two search spaces, the terminal may expect that PDCCH MOs of the two search spaces are all included in the COT after the channel access procedure success. Alternatively, if the latter one of the PDCCH MOs in time of the two search spaces is not included in the COT after the base station and the terminal succeed in the channel access procedure, the COT may be extended to include the latter PDCCH MO in time. Extending the COT to include the latter PDCCH MO in time may be configured through the higher layer signaling, activated through the MAC-CE, dynamically indicated by the DCI, notified to the terminal with a combination of the signalings, or predefined in standard. Alternatively, if the latter one of the PDCCH MOs in time of the two search spaces is not included in the COT after the base station and the terminal succeed in the channel access procedure, the terminal may expect a single PDCCH transmission based on one PDCCH MO included in the COT, which may be configured through the higher layer signaling, activated by the MAC-CE, dynamically indicated by the DCI, notified to the terminal with a combination of the signalings, or predefined in standard.

In the method 5-1, the terminal may obtain in advance the PDCCH MOs of the two search spaces linked with the higher layer signaling as semi-static information. Hence, if performing the channel access procedure, the terminal may expect to perform the channel access procedure prior to the former PDCCH MO in time among a plurality of search spaces including the CORESET frequency resource allocation in a specific subband, to carry out the PDCCH monitoring right after the access success.

The method 5-1 may be used only with specific higher layer signaling if both the UE capability of the PDCCH repetition transmission and the UE capability of the unlicensed band operation and the frequency resource allocation method per subband of the CORESET are reported. Alternatively, the method 5-1 may be used only with two UE capability reports. Alternatively, besides the UE capability of the PDCCH repetition transmission and the UE capability of the unlicensed band operation and the frequency resource allocation method per subband of the CORESET, additional UE capability supporting the PDCCH repetition transmission and the unlicensed band operation and a frequency resource allocation method combination per subband of the CORESET and its corresponding higher layer signaling may be configured and used, or the two UE capability reports and the additional UE capability report may be used.

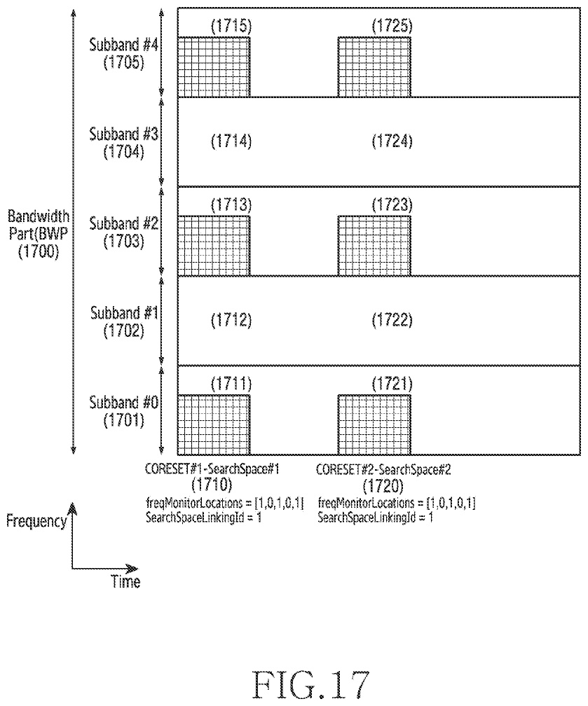

FIG. 17 illustrates an example of PDCCH repetition transmission in an unlicensed band according to an embodiment of the present disclosure.

Referring to FIG. 17, the terminal may be configured from the base station with two search spaces SearchSpace #1 and SearchSpace #2 and two CORESETs CORESET #1 and CORESET #2 through high layer signaling. CORESET #1 and SearchSpace #1 may be linked or associated 1710, and CORESET #2 and SearchSpace #2 may be linked or associated 1720. The terminal may be configured with the same freqMonitorLocations bitmap value as [1,0,1,0,1] with respect to the two search spaces, and SearchSpaceLinkingId as 1. Hence, frequency resource allocation information of CORESET #1 and CORESET #2 may be applied to a subband #0 1711 and 1721, a subband #2 1713 and 1723, and a subband #4 1715 and 1725. As shown in FIG. 17, a subband #1 1712 and 1722 and a subband #3 1714 and 1724 configured with freqMonitorLocations bitmap as 0 may not have the frequency resource allocation information of CORESET #1 and CORESET #2. Based on the configuration information received through the higher layer signaling, if successfully performing the channel access procedure on the subband #0, the terminal may PDCCH repetition transmission from the base station.

[Method 5-2]

If the base station and the terminal consider the PDCCH repetition transmission in the unlicensed band, the base station may provide the terminal with configuration information of two search spaces linked through higher layer signaling, wherein freqMonitorLocations information configured in each search space may have no specific restriction. That is, freqMonitorLocations bitmap of the two search spaces may configure identical or different bit values for a specific subband location. In so doing, the terminal may differently interpret the PDCCH reception, depending on a combination of two bits of the specific subband location of freqMonitorLocations bitmap of the two search spaces. If the two bits of the specific subband location of freqMonitorLocations bitmap of the two search spaces linked with the higher layer signaling are all 1, that is, if frequency resource allocation information of each CORESET linked to the two search spaces exists at the corresponding subband location, the terminal may regard and receive the PDCCH repetition transmission.

If only one of the two bit values of the specific subband location of freqMonitorLocations bitmap of the two search spaces linked with the higher layer signaling is 1, that is, if the frequency resource allocation information of each CORESET linked to one of the two search spaces exists at the corresponding subband location, the terminal may regard and receive the single PDCCH repetition transmission. If the two bit values of the specific subband location of freqMonitorLocations bitmap of the two search spaces linked with the higher layer signaling are all 0, that is, if no frequency resource allocation information of each CORESET linked to the two search spaces exists at the corresponding subband location, the terminal may not expect the PDCCH reception in the two search spaces in the corresponding subband.

In the method 5-2, if the base station and the terminal succeed in the channel access procedure of a specific subband and the corresponding subband has the frequency resource allocation information of the CORESETs linked to the two search spaces respectively by the freqMonitorLocations configuration information of the two search spaces, the terminal may expect that the PDCCH Mos of the two search spaces are all included in the COT after the channel access procedure success. Alternatively, if the latter one of the PDCCH Mos in time of the two search spaces is not included in the COT after the base station and the terminal succeed in the channel access procedure, the COT may be extended to include the latter PDCCH MO in time. Extending the COT to include the latter PDCCH MO in time may be configured through the higher layer signaling, activated through the MAC-CE, dynamically indicated by the DCI, notified to the terminal with a signaling combination, or predefined in standard. Alternatively, if the latter one of the PDCCH Mos in time of the two search spaces is not included in the COT after the base station and the terminal succeed in the channel access procedure, the terminal may expect a single PDCCH transmission based on one PDCCH MO included in the COT. The single PDCCH transmission based on one PDCCH MO included in the COT may be configured through the higher layer signaling, activated by the MAC-CE, dynamically indicated by the DCI, notified to the terminal with a signaling combination, or predefined in standard.

In the method 5-2, the terminal may obtain in advance the PDCCH Mos of the two search spaces linked by the higher layer signaling as the semi-static information. Hence, if performing the channel access procedure, the terminal may expect to perform the channel access procedure prior to the former PDCCH MO in time among the plurality of the search spaces including the CORESET frequency resource allocation in the specific subband, to carry out the PDCCH monitoring right after the access success.

In the method 5-2, if the base station and the terminal succeed in the channel access procedure with respect to two subbands, one of the two subbands has frequency resource allocation of a CORESET linked to one of the two search spaces linked with the higher layer signaling, and the other subband has frequency resource allocation of a CORESET linked to the other one of the two search spaces linked with the higher layer signaling, the terminal may expect that the PDCCH to be transmitted at the PDCCH MO of the two subbands is repetition transmission.

The method 5-2 may be used upon configuring specific higher layer signaling if both the UE capability of the PDCCH repetition transmission and the UE capability of the unlicensed band operation and the frequency resource allocation method per subband of the CORESET are reported. Alternatively, the method 5-2 may be used only with the two UE capability reports. Alternatively, besides the UE capability of the PDCCH repetition transmission and the UE capability of the unlicensed band operation and the frequency resource allocation method per subband of the CORESET, additional UE capability supporting the PDCCH repetition transmission and the unlicensed band operation and a frequency resource allocation method combination method per subband of the CORESET and its corresponding higher layer signaling may be configured and used, or the two UE capability reports and the additional UE capability report may be used.

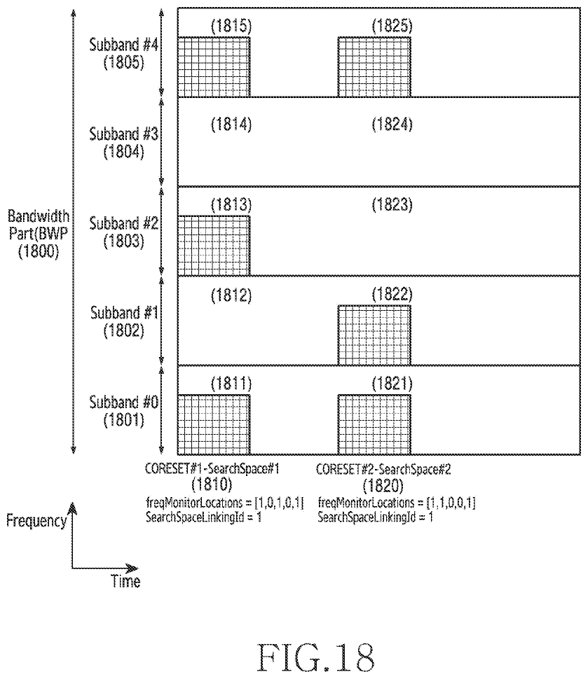

FIG. 18 illustrates another example of PDCCH repetitive transmission in an unlicensed band according to an embodiment of the present disclosure. The terminal may be configured with two search spaces SearchSpace #1 and SearchSpace #2 and two CORESETs CORESET #1 and CORESET #2 from the base station through high layer signaling, CORESET #1 and SearchSpace #1 may be linked or associated 1810, and CORESET #2 and SearchSpace #2 may be linked or associated 1820. In this case, freqMonitorLocations of SearchSpace #1 may be set to [1, 0, 1, 0, 1], freqMonitorLocations of SearchSpace #2 may be set to [1, 1, 0, 0, 1], and SearchSpaceLinkingId may be set to 1. Hence, frequency resource allocation information of CORESET #1 may be applied to a subband #0 1811, a subband #2 1813, and a subband #4 1815, and frequency resource allocation information of CORESET #2 may be applied to a subband #0 1821, a subband #2 1822, and a subband #4 1825. As shown in FIG. 18, the subband #1 1812 and a subband #3 1814 configured with freqMonitorLocations bitmap as 0 may not have the frequency resource allocation information of CORESET #1, and the subband #2 1823 and a subband #3 1824 configured with freqMonitorLocations bitmap as 0 may not have the frequency resource allocation information of CORESET #2. If succeeding in the channel access procedure of the subband #0 or the subband #4, the terminal may receive the PDCCH repetition transmission from the base station. If succeeding in the channel access procedure of the subband #1 or the subband #2, the terminal may receive the single PDCCH repetition transmission from the base station. If succeeding in the channel access procedure of the subband #1 or the subband #2, the terminal may decode by assuming that the PDCCH transmitted in the CORESET #1 1813 of the subband #2 and the CORESET #2 1822 of the subband #1 are repeatedly transmitted.

[Method 5-3]

If the base station and the terminal consider the PDCCH repetition transmission in the unlicensed band, the base station may provide the terminal with configuration information of two search spaces linked through higher layer signaling. If a first search space and a second search space are linked or associated with the higher layer signaling, and a MO in a slot of the first search space precedes in time a MO in a slot of the second search space, freqMonitorLocations bitmap configured in the first search space may be configured to include freqMonitorLocations bitmap configured in the second search space. This configuration may enable the PDCCH reception using the former MO in time, if the base station and the terminal succeeds in the channel access procedure of a specific subband. For example, if the freqMonitorLocations bitmap configured in the first search space is [1, 0, 1, 0, 1], the freqMonitorLocations bitmap configured in the second search space may allow 0 or 1 at the first, third, and fifth bits and allow only 0 at the second and fourth bits. That is, the terminal may not expect the freqMonitorLocations bitmap value of 1 configurable in the second search space at the second and fourth bits.

freqMonitorLocations bitmaps of the two search spaces may set to identical or different bit values for a specific subband location. In this case, the terminal may differently interpret the PDCCH reception, depending on a combination of the two bit values of the specific subband location of the freqMonitorLocations bitmap of the two search spaces. For example, if the two bit values of the specific subband location of the freqMonitorLocations bitmap of the two search spaces linked with the higher layer signaling are all 1, that is, if the frequency resource allocation information of the CORESETs linked to the two search spaces exists at the corresponding subband location, the terminal may regard and receive the PDCCH repetition transmission.

If only one of the two bit values of the specific subband location of the freqMonitorLocations bitmap of the two search spaces linked with the higher layer signaling is 1, that is, if the frequency resource allocation information of the CORESET linked to one of the two search spaces exists at the corresponding subband location, the terminal may regard and receive the single PDCCH repetition transmission. If the two bits of the specific subband location of the freqMonitorLocations bitmap of the two search spaces linked with the higher layer signaling are all 0, that is, if no frequency resource allocation information of the CORESETs linked to the two search spaces exists at the corresponding subband location, the terminal may not expect the PDCCH reception of the two search spaces in the corresponding subband.

In the method 5-3, if the base station and the terminal succeed in the channel access procedure of the specific subband and the corresponding subband has the frequency resource allocation information of the CORESETs linked to the two search spaces by the freqMonitorLocations configuration information of the two search spaces, the terminal may expect that the PDCCH MOs of the two search spaces are all included in the COT after the channel access procedure success. Alternatively, if the latter one of the PDCCH MOs in time of the two search spaces is not included in the COT after the base station and the terminal succeed in the channel access procedure, the COT may be extended to include the latter PDCCH MO in time. Extending the COT to include the latter PDCCH MO in time may be configured through the higher layer signaling, activated through the MAC-CE, dynamically indicated by the DCI, notified to the terminal with a signaling combination, or predefined in standard. Alternatively, if the latter one of the PDCCH MOs in time of the two search spaces is not included in the COT after the base station and the terminal succeed in the channel access procedure, the terminal may expect the single PDCCH transmission based on one PDCCH MO included in the COT. The single PDCCH transmission based on one PDCCH MO included in the COT may be configured through the higher layer signaling, activated by the MAC-CE, dynamically indicated by the DCI, notified to the terminal with a signaling combination, or predefined in standard.

In the method 5-3, the terminal may obtain in advance the PDCCH MOs of the two search spaces linked by the higher layer signaling as the semi-static information. If performing the channel access procedure, the terminal may expect to perform the channel access procedure prior to the former PDCCH MO in time among the plurality of the search spaces including the CORESET frequency resource allocation in the specific subband, to carry out the PDCCH monitoring right after the access success.

In the method 5-3, if the base station and the terminal succeed in the channel access procedure with respect to the two subbands, one of the two subbands has the frequency resource allocation of the CORESET linked to one of the two search spaces linked with the higher layer signaling and the other subband has the frequency resource allocation of the CORESET linked to the other one of the two search spaces linked with the higher layer signaling, the terminal may expect that the PDCCH to be transmitted at the PDCCH MO of the two subbands is the repetition transmission.

The method 5-3 may be used upon configuring specific higher layer signaling if both the UE capability of the PDCCH repetition transmission and the UE capability of the unlicensed band operation and the frequency resource allocation method per subband of the CORESET are reported. Alternatively, the method 5-3 may be used merely with the two UE capability reports. Alternatively, besides the UE capability of the PDCCH repetition transmission and the UE capability of the unlicensed band operation and the frequency resource allocation method per subband of the CORESET, additional UE capability supporting the PDCCH repetition transmission and the unlicensed band operation and the frequency resource allocation method combination method per subband of the CORESET and its corresponding higher layer signaling may be configured and used, or the two UE capability reports and the additional UE capability report may be used.

[Method 5-4]

In the PDCCH repetition transmission in the unlicensed band, the base station and the terminal may not support the frequency resource allocation scheme per subband with respect to the CORESETs linked or associated to the two search spaces respectively linked through higher layer signaling. That is, in a cell or a band (or a subband) corresponding to the unlicensed band, the terminal may expect no higher layer signaling freqMonitorLocations configured in both of the two search spaces linked with the higher layer signaling.

In the method 5-4, the terminal may select and report only one of the UE capability of the PDCCH repetition transmission, and the UE capability of the unlicensed band operation and the frequency resource allocation method per subband of the CORESET. Alternatively, even if both of the two UE capability are reported, the terminal may not support the frequency resource allocation method per subband of the CORESET while supporting the PDCCH repetition transmission in the unlicensed band.

[Method 5-5]

In the PDCCH repetition transmission in the unlicensed band, even if at least one of the search spaces linked or associated with the higher layer signaling supports the frequency resource allocation method per subband of the CORESET, the base station and the terminal may assume different PDCCH transmission schemes per subband. If the first and second search spaces are linked or associated with the higher layer signaling, the first search space includes the higher layer signaling freqMonitorLocations, and the second search space does not include the higher layer signaling freqMonitorLocations for the PDCCH repetition transmission, the terminal may perform the PDCCH repetition transmission in the first subband of the first search space, and a frequency resource corresponding to the first subband of the first search space among the whole frequency resources of the CORESET linked or associated to the second search space. At this time, the independent PDCCH single transmission may be performed in other subband than the first subband of the first search space. Also, the independent PDCCH single transmission may be expected in a frequency resource not corresponding to the first subband of the first search space among the whole frequency resources of the CORESET linked or associated to the second search space.

In the method 5-5, the terminal may report both the UE capability of the PDCCH repetition transmission, and the UE capability of the unlicensed band operation and the frequency resource allocation method per subband of the CORESET, or require additional third UE capability report in addition to the two UE capability reports. If the third UE capability report is required, additional higher layer signaling corresponding to the third UE capability may be configured.

[Method 5-6]

The base station and the terminal may not support the PDCCH repetition transmission in the unlicensed band. That is, the terminal may select and report only one of the UE capability of the PDCCH repetition transmission, and the UE capability of the unlicensed band operation and the frequency resource allocation method per subband of the CORESET. Alternatively, even if both of the two UE capability are reported, the terminal may not support the PDCCH repetition transmission in the unlicensed band. In this case, the cell or the band corresponding to the unlicensed band may not have the two search spaces linked or associated with the higher layer signaling. That is, in the cell or the band (or subband) corresponding to the unlicensed band, the terminal may expect only the PDCCH single transmission from the base station.

The base station or the terminal may be configured with one of [Method 5-1] through [Method 5-6] through the higher layer signaling, or activated with one of [Method 5-1] through [Method 5-6] through the MAC-CE, dynamically indicated through the DCI, or predefine in standard. Independent UE capability report signaling may be defined for each method, and the terminal and the base station may determine whether to support each method through the combination of the existing PDCCH repetition transmission related UE capability and the UE capability of the unlicensed band operation and the frequency resource allocation method per subband of the CORESET, as mentioned above.

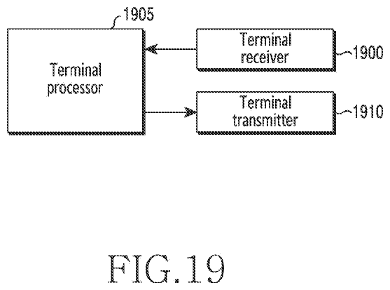

FIG. 19 illustrates a terminal structure in a wireless communication system according to an embodiment of the present disclosure.

Referring to FIG. 19, the terminal may include a transceiver referring to a terminal receiver 1900 and a terminal transmitter 1910, a memory (not shown) and a terminal processor 1905 (or a terminal controller or processor). According to a communication method of the terminal, the transceiver 1900 and 1910, the memory and the terminal processor 1905 may operate. However, the components of the terminal are not limited to the transceiver 1900 and 1910, the memory and the terminal processor 1905. For example, the terminal may include more or fewer components than the aforementioned components. Besides, the transceiver 1900 and 1910, the memory, and the processor 1905 may be implemented with a single chip.

The transceiver 1900 and 1910 may transmit and receive a signal to and from the base station. Herein, the signal may include control information and data. For doing so, the transceiver 1900 and 1910 may include a radio frequency (RF) transmitter for up-converting and amplifying a frequency of a transmitted signal, an RF receiver for low-noise-amplifying and down-converting a received signal and so on. However, this is only one embodiment of the transceiver 1900 and 1910, and the components of the transceiver 1900 and 1910 are not limited to the RF transmitter and the RF receiver.

The transceiver 1900 and 1910 may receive a signal over a radio channel, output the signal to the processor 1905, and transmit a signal outputted from the processor 1905 over a radio channel.

The memory may store a program and data necessary for the operation of the terminal. In addition, the memory may store control information or data included in the signal transmitted and received by the terminal. The memory may be configured with a storage medium such as a read only memory (ROM), a random access memory (RAM), a hard disk, a compact disc (CD)-ROM and a digital versatile disc (DVD), or a combination thereof. In addition, a plurality of memories may be provided.

The processor 1905 may control a series of processes to operate the terminal according to the above-described embodiments of the disclosure. For example, the processor 1905 may control the component of the terminal to receive DCI including two layers and thus concurrently receive a plurality of PDSCHs. The processor 1905 may include at least one processor, and the processor 1905 may execute the program stored in the memory to thus control the component of the terminal.

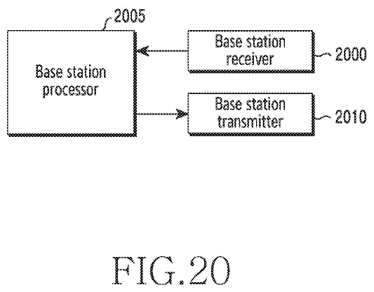

FIG. 20 illustrates a structure of a base station in a wireless communication system according to an embodiment of the present disclosure.

Referring to FIG. 20, the base station may include a transceiver 2000 and 2010 referring to a base station receiver 2000 and a base station transmitter 2010, a memory (not shown) and a base station processor 2005 (or a base station controller or processor). According to a communication method of the base station, the transceiver 2000 and 2010, the memory, and the base station processor 2005 may operate. However, the components of the base station are not limited to the above-described example. For example, the base station may include more or fewer components than the base station receiver 2000, the base station transmitter 2010, the memory and the base station processor 2005. Besides, the transceiver 2000 and 2010, the memory, and the processor 2005 may be implemented with a single chip.

The transceiver 2000 and 2010 may transmit and receive a signal to and from the terminal. Herein, the signal may include control information and data. For doing so, the transceiver 2000 and 2010 may include an RF transmitter for up-converting and amplifying a frequency of a transmitted signal, an RF receiver for low-noise-amplifying and down-converting a received signal and so on. However, this is only one embodiment of the transceiver 2000 and 2010, and the components of the transceiver 2000 and 2010 are not limited to the RF transmitter and the RF receiver.

The transceiver 2000 and 2010 may receive a signal over a radio channel, output the signal to the processor 2005, and transmit a signal outputted from the processor 2005 over a radio channel.

The memory may store a program and data necessary for the operation of the base station. In addition, the memory may store control information or data included in the signal transmitted and received by the base station. The memory may be configured with a storage medium such as a ROM, a RAM, a hard disk, a CD-ROM, and a DVD, or a combination thereof. In addition, a plurality of memories may be provided.

The processor 2005 may control a series of processes to operate the base station according to the above-described embodiment of the disclosure. For example, the processor 2005 may control each component of the base station to configure and transmit two-layer DCI including allocation information of multiple PDSCHs. The processor 2005 may include at least one processor, and the processor 2005 may execute the program stored in the memory to thus control the component of the base station.

According to various embodiments of the disclosure, in a wireless communication system, a method of a terminal for transmitting and receiving control information may include receiving, from a base station, configuration information related to a control channel, the configuration information related to the control channel including first control resource set information and first search space information, and second control resource set information and second search space information, and receiving, from the base station, a signal of PDCCH repetition transmission, based on the configuration information related to the control channel, the first search space information may include a first bitmap related to a frequency location, and the second search space information may include a second bitmap related to a frequency location.

According to various embodiments of the disclosure, in a wireless communication system, an apparatus of a terminal for transmitting and receiving control information may include a transceiver, and at least one processor connected with the transceiver, the at least one processor may be configured to receive, from a base station, configuration information related to a control channel, the configuration information related to the control channel including first control resource set information and first search space information, and second control resource set information and second search space information, and to receive, from the base station, a signal of PDCCH repetition transmission, based on the configuration information related to the control channel, the first search space information may include a first bitmap related to a frequency location, and the second search space information may include a second bitmap related to a frequency location.

According to various embodiments of the disclosure, in a wireless communication system, a method of a base station for transmitting and receiving control information may include transmitting, to a terminal, configuration information related to a control channel, the configuration information related to the control channel including first control resource set information and first search space information, and second control resource set information and second search space information, and transmitting, to the terminal, a signal of PDCCH repetition transmission, based on the configuration information related to the control channel, the first search space information may include a first bitmap related to a frequency location, and the second search space information may include a second bitmap related to a frequency location.

The methods according to the embodiments described in the claims or the specification of the disclosure may be implemented in software, hardware, or a combination of hardware and software.

As for the software, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods according to the embodiments described in the claims or the specification of the disclosure.

Such a program (software module, software) may be stored to a random access memory, a non-volatile memory including a flash memory, a ROM, an electrically erasable programmable ROM (EEPROM), a magnetic disc storage device, a CD-ROM, DVD or other optical storage device, and a magnetic cassette. Alternatively, it may be stored to a memory combining part or all of those recording media. A plurality of memories may be included.

Also, the program may be stored in an attachable storage device accessible via a communication network such as internet, intranet, local area network (LAN), wide LAN (WLAN), or storage area network (SAN), or a communication network by combining these networks. Such a storage device may access a device which executes an embodiment of the disclosure through an external port. In addition, a separate storage device on the communication network may access the device which executes an embodiment of the disclosure.

In the specific embodiments of the disclosure, the components included in the disclosure are expressed in a singular or plural form. However, the singular or plural expression is appropriately selected according to a provided situation for the convenience of explanation, the disclosure is not limited to a single component or a plurality of components, the components expressed in the plural form may be configured as a single component, and the components expressed in the singular form may be configured as a plurality of components.

Meanwhile, the embodiments of the disclosure shown in the specification and the drawings present merely specific examples to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. For example, one embodiment of the disclosure may be partially combined with another embodiment to operate the base station and the terminal. For example, the first and embodiment and the second embodiment of the disclosure may be partially combined to operate the base station and the terminal. In addition, although the above embodiments have been described by way of the FDD LTE system, other variants based on the technical idea of the embodiments may be implemented in other systems such as TDD LTE and 5G or NR systems.

Meanwhile, in the drawings for explaining the method of the disclosure, the order of description does not necessarily correspond to the execution order, and the precedence relationship may be changed or may be executed in parallel.

Alternatively, the drawings explaining the method of the disclosure may omit some component and include only some element therein without departing from the essential spirit and the scope of the disclosure.

Further, the method of the disclosure may be fulfilled by combining some or all of the contents of each embodiment without departing from the essential spirit and the scope of the disclosure.

Various embodiments of the disclosure have been described. The above description of the disclosure is merely for the purpose of illustration, and is not intended to limit embodiments of the disclosure to the embodiments set forth herein. Those skilled in the art will appreciate that other specific modifications and changes may be easily made thereto without changing the technical idea or essential features of the disclosure. The scope of the disclosure should be determined not by the above description but by the appended claims, and all changes and modifications derived from the meaning and the scope of the claims and equivalent concepts thereof shall be construed as falling within the scope of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, first configuration information for a first search space associated with a first control resource set (CORESET) and second configuration information for a second search space associated with a second CORESET, wherein the first search space and the second search space have a same linking index;
receiving a first physical downlink control channel (PDCCH) based on the first configuration information, wherein the first PDCCH is received on at least one first subband of an unlicensed band based on first frequency monitoring location information included in the first configuration information; and
receiving a second PDCCH based on the second configuration information, wherein the second PDCCH is received on at least one second subband of the unlicensed band based on second frequency monitoring location information included in the second configuration information,
wherein a first bitmap of the first frequency monitoring location information and a second bitmap of the second frequency monitoring location information are same.

2. The method of claim 1, wherein the first PDCCH received on the at least one first subband and the second PDCCH received on the at least one second subband which is the same frequency location with the at least one first subband have same downlink control information (DCI) payload, and
wherein the first PDCCH is repeated for the at least one first subband and the second PDCCH is repeated for the at least one second subband.

3. The method of claim 1, wherein the first bitmap of the first frequency monitoring location information indicates the at least one first subband, and the second bitmap of the second frequency monitoring location information indicates the at least one second subband.

4. The method of claim 1, wherein a PDCCH monitoring occasion of the first search space and a PDCCH monitoring occasion of the second search space are within a same channel occupancy time (COT).

5. The method of claim 1, wherein the first PDCCH is received from a first transmission and reception point (TRP) and the second PDCCH is received from a second TRP different from the first TRP.

6. A method performed by a base station in a wireless communication system, the method comprising:
transmitting, to a terminal, first configuration information for a first search space associated with a first control resource set (CORESET) and second configuration information for a second search space associated with a second CORESET, wherein the first search space and the second search space have a same linking index;
transmitting, to the terminal, a first physical downlink control channel (PDCCH) based on the first configuration information, wherein the first PDCCH is transmitted on at least one first subband of an unlicensed band based on first frequency monitoring location information included in the first configuration information; and
transmitting, to the terminal, a second PDCCH based on the second configuration information, wherein the second PDCCH is transmitted on at least one second subband of the unlicensed band based on second frequency monitoring location information included in the second configuration information,
wherein a first bitmap of the first frequency monitoring location information and a second bitmap of the second frequency monitoring location information are same.

7. The method of claim 6, wherein the first PDCCH transmitted on the at least one first subband and the second PDCCH transmitted on the at least one second subband which is the same frequency location with the at least one first subband have same downlink control information (DCI) payload, and
wherein the first PDCCH is repeated for the at least one first subband and the second PDCCH is repeated for the at least one second subband.

8. The method of claim 6, wherein the first bitmap of the first frequency monitoring location information indicates the at least one first subband, and the second bitmap of the second frequency monitoring location information indicates the at least one second subband.

9. The method of claim 6, wherein a PDCCH monitoring occasion of the first search space and a PDCCH monitoring occasion of the second search space are within a same channel occupancy time (COT).

10. The method of claim 6, wherein the first PDCCH is transmitted via a first transmission and reception point (TRP) and the second PDCCH is transmitted via a second TRP different from the first TRP.

11. A terminal in a wireless communication system, the terminal comprising:
a transceiver; and
a controller coupled with the transceiver and configured to:
receive, from a base station, first configuration information for a first search space associated with a first control resource set (CORESET) and second configuration information for a second search space associated with a second CORESET, wherein the first search space and the second search space have a same linking index,
receive a first physical downlink control channel (PDCCH) based on the first configuration information, wherein the first PDCCH is received on at least one first subband of an unlicensed band based on first frequency monitoring location information included in the first configuration information, and
receive a second PDCCH based on the second configuration information, wherein the second PDCCH is received on at least one second subband of the unlicensed band based on second frequency monitoring location information included in the second configuration information,
wherein a first bitmap of the first frequency monitoring location information and a second bitmap of the second frequency monitoring location information are same.

12. The terminal of claim 11, wherein the first PDCCH received on the at least one first subband and the second PDCCH received on the at least one second subband which is the same frequency location with the at least one first subband have same downlink control information (DCI) payload, and
wherein the first PDCCH is repeated for the at least one first subband and the second PDCCH is repeated for the at least one second subband.

13. The terminal of claim 11, wherein the first bitmap of the first frequency monitoring location information indicates the at least one first subband, and the second bitmap of the second frequency monitoring location information indicates the at least one second subband.

14. The terminal of claim 11, wherein a PDCCH monitoring occasion of the first search space and a PDCCH monitoring occasion of the second search space are within a same channel occupancy time (COT).

15. The terminal of claim 11, wherein the first PDCCH is received from a first transmission and reception point (TRP) and the second PDCCH is received from a second TRP different from the first TRP.

16. A base station in a wireless communication system, the base station comprising:
a transceiver; and
a controller coupled with the transceiver and configured to:
transmit, to a terminal, first configuration information for a first search space associated with a first control resource set (CORESET) and second configuration information for a second search space associated with a second CORESET, wherein the first search space and the second search space have a same linking index,
transmit, to the terminal, a first physical downlink control channel (PDCCH) based on the first configuration information, wherein the first PDCCH is transmitted on at least one first subband of an unlicensed band based on first frequency monitoring location information included in the first configuration information, and
transmit, to the terminal, a second PDCCH based on the second configuration information, wherein the second PDCCH is transmitted on at least one second subband of the unlicensed band based on second frequency monitoring location information included in the second configuration information,
wherein a first bitmap of the first frequency monitoring location information and a second bitmap of the second frequency monitoring location information are same.

17. The base station of claim 16, wherein the first PDCCH transmitted on the at least one first subband and the second PDCCH transmitted on the at least one second subband which is the same frequency location with the at least one first subband have same downlink control information (DCI) payload, and
wherein the first PDCCH is repeated for the at least one first subband and the second PDCCH is repeated for the at least one second subband.

18. The base station of claim 16, wherein the first bitmap of the first frequency monitoring location information indicates the at least one first subband, and the second bitmap of the second frequency monitoring location information indicates the at least one second subband.

19. The base station of claim 16, wherein a PDCCH monitoring occasion of the first search space and a PDCCH monitoring occasion of the second search space are within a same channel occupancy time (COT).

20. The base station of claim 16, wherein the first PDCCH is transmitted via a first transmission and reception point (TRP) and the second PDCCH is transmitted via a second TRP different from the first TRP.
